(19) United States
(12) Patent Application Publication
(10) Pub. No.: US 2008/0010545 A1
(43) Pub. Date: Jan. 10, 2008

(54) COMPUTER SYSTEM AND METHOD FOR MONITORING EXECUTION OF APPLICATION PROGRAM

(76) Inventors: Daisuke Tashiro, Kumamoto (JP); Shinichi Kawamoto, Tokyo (JP); Tomohiro Nakamura, Hachioji (JP); Tsunehiko Baba, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/746,910

(22) Filed: May 10, 2007

(30) Foreign Application Priority Data
May 25, 2006 (JP) 2006-145199

(51) Int. Cl. G06F 11/00

(52) U.S. Cl. 714/39

(57) ABSTRACT

To realize monitoring of an application program according to an application monitoring request described in highly abstract design information created in a development process of an application, program implementation must be understood, and work for converting the monitoring request into description of an implementation level must be carried out. Thus, it is impossible to readily execute the requested monitoring. A point of the design information is correlated with a point of a program code based on a correspondence among components of pieces of design information at respective stages in the application development process.

### CLAIM OF PRIORITY

The present application claims priority from Japanese application JP2006-145199 filed on May 25, 2006, the content of which is hereby incorporated by reference into this application.

### BACKGROUND OF THE INVENTION

This invention relates to a method of monitoring a behavior of an application program during execution thereof, and more particularly, to a method of executing setting and control of application program monitoring.

An operation administrator or business administrator of an information system monitors a state of a system or a business by using a log output from a business application. For the log, there are a system log output from each tier, such as hardware, an OS, an application server, or the like, of the information system which executes a business application and an application log output from the business application. Each tier of the information system has a function of outputting a system log, and a function of customizing a log to be output during system operation according to a request from the operation or business administrator.

To monitor a state of a business processed by the information system, not the system log but the application log is necessary. There is a possibility that the application log necessary for monitoring the business state may change after the start of operation of the application due to environmental changes such as corporate law revision. Accordingly, a log output from the application must be added or changed after the start of operation.

A method of realizing the function of outputting the application log varies depending on application program implementation forms.

Recently, a development method based on a model has been used in business application development. According to this development method, a business manager or a design consultant models a business process by using a model descriptive language such as business process modeling notation (BPMN) (refer to “Introduction to BPMN” by Stephen A. White, Object Management Group/Business Process Management Initiative, Internet <URL: http://www.bpmn.org/Documents/Introduction %20 to %20BPMN.pdf>). Implementation level specifications of the program are created by changing and detailing the created model to an implementation level model stepwise. Then, based on the created specifications, the application program is implemented (refer to “Java 2 Platform Enterprise Edition Specification, v1.4” by Bill Shannon, Nov. 24, 2003, Sun Microsystems, Inc., Internet <URL: http://java.sun.com/j2ee/j2ee-1_{—}4-fr-spec.pdf>).

FIG. 2 is an explanatory diagram of an application development process and model diagrams created during the process.

Used in application development are a business process diagram 301 created by using the business process modeling notation (BPMN) or the like, a unified modeling language (UML) class diagram 302 created by using a model descriptive language such as a UML, a UML sequence diagram 303, and the like.

The model diagrams such as the business process diagram, the UML class diagram, the UML sequence diagram, and the like used in application development will be generically referred to as design information below.

In such an application development process, first, an abstract business process diagram 301 is created by analyzing a business process and modelizing it. The created business process diagram 301 is detailed stepwise. The detailed business process diagram is further detailed into a model of UML class diagram 302 or a UML sequence diagram 303. By repeating the detailing, an abstract application design model is converted into a model of a level near implementation of an application program. Lastly, an application program code 304 is implemented based on the model of the implementation level.

The recent business application is generally built by combining a plurality of small software components using an object-oriented language. As basic techniques for building such applications, J2EE (refer to “MDA Model Drive Architecture” by David S. Frankel, translated by TEC-J MDA Sectional Committee of Japan IBM Inc., SIB Access Inc., Nov. 1, 2003), and .NET are available. An application implemented by using such basic techniques is executed on an application operation base called a J2EE application server or a .NET application server.

As a different approach, an approach of a service oriented architecture (SOA) which implements various functions constituting the business process as services and implements an application as a loose coupling of the services using a messaging system has been proposed (refer to “SOA Service Oriented Architecture”, JAPAN BEA Systems Inc., published by SE Holdings and Incubations, Co, Ltd., Mar. 22, 2005).

In the application implemented by the SOA, it is possible to monitor a state of a business processed by the application by capturing a message between services in the messaging system (refer to “Understanding BizTalk Server 2004” by David Chappell, October 2003, Microsoft Corporation, Internet URL: http://download.microsoft.com/download/1/1/1/1118730e-ec93-45aa-8c06-97af628 db61d/UnderstandingBizTalkServer2004_J.doc). Since monitoring by the messaging system can be set independently of services, it is possible to realize monitoring of an application level and to customize monitoring contents during operation without any modification of the application. Alternatively, it is possible to add or change contents to be monitored by recording all messages transferred between the services and subsequently referring to the necessary messages.

In the case of a general application which does not employ the SOA approach, it is impossible to monitor a state of a business by capturing an application behavior from the outside unlike in the SOA application. Thus, in the case of adding or changing logs output by the application, since a function of outputting a log must be individually incorporated in the application for each log, the application program had to be changed. As a result, there have been problems in that it takes time and labor to implement a log output code according to each log to be output, and that the operation of the application must be stopped to change the application program.

As a method of solving the problem that the program must be changed to add or change the log output code with respect to the application, there is a bytecode instrumentation technique (refer to U.S. Pat. No. 6,260,187). According to the bytecode instrumentation technique, function addition and changing during program execution is realized by dynamically rewriting a program code of the application program. By using this technique, it is possible to realize dynamic addition and changing of a log output function.

US Patent Application Publication No. 2005-0273667 discloses a system for selecting a program module for outputting a log prepared beforehand by using the bytecode instrumentation technique, and inserting the program module into an application program being executed. As a result, it is possible to add optional application monitoring without stopping the operation of the application.

JP 2005-523518 A discloses a system for inserting a program module for executing monitoring into a designated part of an application program during execution of the application program, and monitoring execution performance. According to this system, which part of the program monitoring is to be executed at is input at a program code level. Then, a program module prepared beforehand to execute monitoring is automatically inserted into the input position, and monitoring is executed.

To solve the problem of time and labor to implement a log output code, there is a method of automatically generating log output codes. “ManageEngine JMX Studio 5 Product Documentation” by AdventNet, Inc., 2004, AdventNet. Inc., Internet <URL: http://manageengine.adventnet.com/products/jmxstudio/AdventNetMana geEngineJMXStudio.pdf> discloses a system for automatically generating a program module for monitoring execution of an application. According to this system, a program module for monitoring execution of an application by inputting a place of executing monitoring and data to be monitored at that place at a program code level is automatically generated.

As another method of realizing adding or changing of logs to be output during the operation of the application, JP 2003-233515 A discloses a system which includes a user interface for selecting a monitoring function incorporated beforehand in the application during operation of the application and controlling execution of monitoring. According to this method, it is possible to control execution of monitoring during the operation within a range of the monitoring function incorporated before the application operation. However, no selectable monitoring function can be added or changed during the application operation.

When monitoring of the execution of the application is carried out, performance deterioration caused by the execution of monitoring must be taken into consideration. Processing of monitoring the execution of the application and outputting monitoring data generates a certain load. Thus, the monitoring must be carried out so that the monitoring load may not affect the execution of the application program as much as possible.

Items to be monitored may include those which do not need to be constantly monitored but should be monitored under specific situations. If there are many such items to be monitored, constant monitoring of the items increases a monitoring load, resulting in that the load may greatly affect the execution of the application. To deal with this problem, there is a method of setting conditions for executing monitoring and controlling the execution of monitoring as occasion demands instead of constantly executing all monitoring tasks. JP 2004-206495 A discloses a system for controlling whether to obtain another item to be monitored according to a value of a certain item to be monitored. This control enables execution of necessary monitoring according to a situation without imposing any monitoring loads more than necessary. According to this system, conditions for executing monitoring are set by setting a threshold value of monitoring data and an item to be monitored which is executed when the threshold value is exceeded.

JP 2001-175508 A discloses a system for measuring time necessary for output a log, and adjusting a log output level so that the time necessary for outputting the log is set equal to or less than a certain rate with respect to time necessary for executing the entire application in a log output device used in the application to output logs.

### SUMMARY OF THE INVENTION

The conventional techniques for monitoring the application programs have had the following problems.

First, according to the conventional technique, to add or change a monitoring function to the application program, a program module for executing monitoring is automatically generated, and the generated program module is applied during the application execution. However, to use this conventional technique, a place (point) of executing monitoring and data of a monitoring target must be input at a program code level.

Generally, it is frequently the operation administrator or business administrator that needs a log to be added or changed. The operation or business administrator usually has no knowledge of an application implementation program code. Accordingly, the operation or business administrator cannot input contents to be monitored at the program code level, which are necessary for using the conventional technique. Thus, an application designer or a programmer who understands the program code must create and input necessary information upon reception of a request from the operation or business administrator. Its time and labor interferes quick addition or changing of the monitoring function.

To deal with this problem, pieces of information to be input are prepared beforehand, and information which the operation administrator selects from the pieces of information can be applied. However, it is difficult to grasp all monitoring contents likely to be necessary beforehand, and to prepare necessary pieces of input information. Thus, the method cannot deal with a case where monitoring contents unexpected beforehand must be added, and provides no essential solution.

Second, by using the conventional technique, it is possible to control items to be monitored according to a state of the application. In this case, items to be monitored which are used for judging conditions are designated when conditions for controlling monitoring execution are specified. Further, items to be monitored which are targets to be controlled according to a state are designated. At this time, when the items to be monitored which can be designated are given names at the program code level, it is impossible to properly set monitoring control unless the program code is understood. When there is no function of monitoring data to be used for judging the conditions, it is necessary to add a new monitoring function.

According to the conventional technique, monitoring execution is controlled by filtering an output of monitoring data from the application. Thus, the program code for monitoring is incorporated in the application program irrespective of a presence of the output of the monitoring data, and the monitoring code is processed according to the execution of the application. As a result, even if the output of the monitoring data is controlled, a monitoring load cannot be eliminated completely.

Third, it is generally difficult to estimate the monitoring load without understanding program implementation. If the first problem is solved, it is possible to add or change an application monitoring function without being aware of implementation of the application program. In this case, however, the unintentional addition of the monitoring function of a high monitoring load to the application program may cause serious performance deterioration in execution of the application program.

According to the conventional technique, because the monitoring load is measured in the log output device outside the application, it has been impossible to obtain or generate monitoring data processed in the application program, and to measure a processing load of an output request to the outside. According to the conventional technique, the load of the entire application monitoring function is measured, and the monitoring execution is controlled based on its result. Thus, it has been impossible to measure the load of each monitoring function and to control the monitoring execution based on its result.

It is therefore a first object of this invention to provide a method of generating a program module for executing designated monitoring without requiring any manual-handling task when a place of executing monitoring and data to be monitored are designated at a business process level that can be understood by a business or operation administrator, and designating a program code level necessary for inserting the program module into an application program.

It is a second object of this invention to enable proper monitoring execution according to a situation by controlling application monitoring based on conditions, without requiring any program knowledge.

It is a third object of this invention to prevent serious performance deterioration in execution of an application program caused by a load of an added monitoring function as a result of adding the new monitoring function to the application program.

According to a representative invention disclosed in this application, there is provided a computer system for executing an application program, comprising a processor and a memory coupled to the processor, wherein the computer system is configured to: hold information indicating a correspondence between a component of design information at a stage of a development process of the application program and a component of design information at the following stage of the development process; and correlate the component of the design information at one of the stages of the development process of the application program with a code of the application program based on the information indicating the correspondence.

According to an embodiment of this invention, even the business or operation administrator having no knowledge of program implementation can designate monitoring of the application program on upstream application design information understandable from a viewpoint of a business.

### BRIEF DESCRIPTION OF THE DRAWINGS

FIG. 1 is a block diagram showing a configuration of an application program monitoring system according to a first embodiment of this invention.

FIG. 2 is an explanatory diagram of an application development process and model diagrams created during the process.

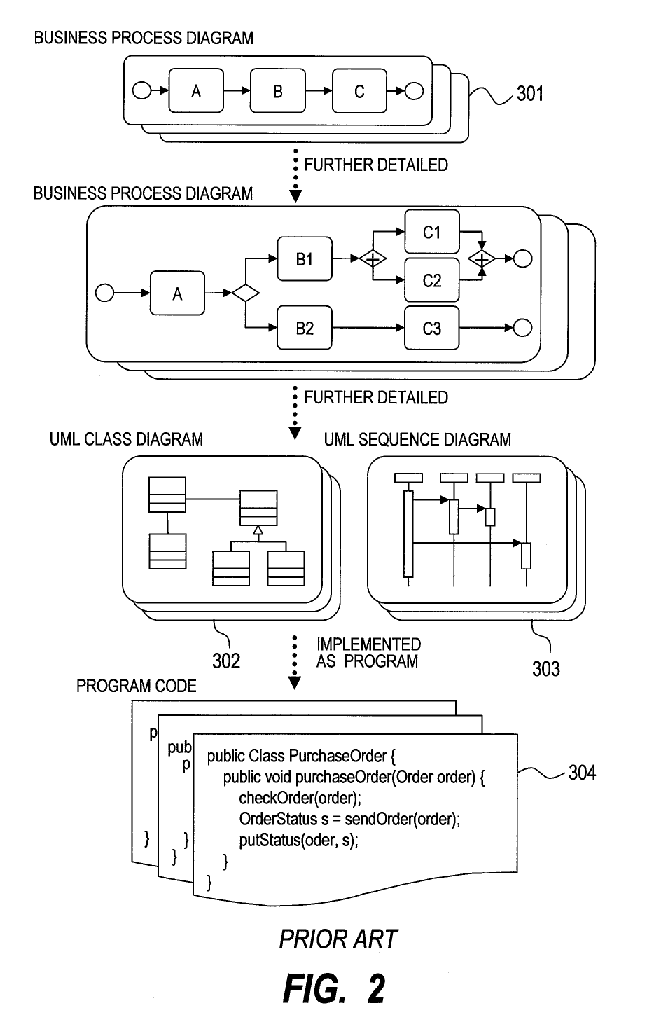

FIG. 3 is an explanatory diagram showing a configuration of the management module according to the first embodiment of this invention.

FIG. 4 is an explanatory diagram showing a configuration example of the probe definition storage module according to the first embodiment of this invention.

FIG. 5 is an explanatory diagram showing a code example of the probe generated as an advice according to the first embodiment of this invention.

FIG. 6 is an explanatory diagram showing an example of a program code for adding the probe to the application program according to the first embodiment of this invention.

FIG. 7 is an explanatory diagram showing an example of a design correspondence according to the first embodiment of this invention.

FIG. 8 is a flowchart of processing where the correspondence retrieval module retrieves a point of inserting the probe according to the first embodiment of this invention.

FIG. 9 is a flowchart of processing where the correspondence retrieval module infers the design correspondence according to the first embodiment of this invention.

FIG. 10 is an explanatory diagram showing an example of the user interface for executing monitoring setting of the application program in the design information according to the first embodiment of this invention.

FIG. 11 is an explanatory diagram showing an example of a monitoring setting table according to the first embodiment of this invention.

FIG. 12 is a block diagram showing a configuration of the system for controlling the monitoring operation of the probe according to the first embodiment of this invention.

FIG. 13 is an explanatory diagram showing a configuration example of the probe control definition storage module according to the first embodiment of this invention.

FIG. 14 is a flowchart of processing where the setting module sets the condition judgment module according to the first embodiment of this invention.

FIG. 15 is a flowchart of processing where the setting module sets the probe control module according to the first embodiment of this invention.

FIG. 16 is a flowchart of processing where the probe control module controls the operation of the probe according to the first embodiment of this invention.

FIG. 17 is an explanatory diagram showing an example of a monitoring control setting user interface used for inputting the probe control definition obtained from the probe control definition storage module according to the first embodiment of this invention.

FIG. 18 is a block diagram showing a configuration of the system for controlling the monitoring operation of the probe based on the measured probe load according to the first embodiment of this invention.

FIG. 19 is a flowchart of processing where the load control module controls the monitoring operation of the probe based on a measured probe load according to the first embodiment of this invention.

FIG. 20 is a flowchart of processing where the load control module measures a probe load by measuring a performance index of the application program according to the first embodiment of this invention.

FIG. 21 is an explanatory diagram showing an example of the user interface regarding measurement of a monitoring operation load according to the first embodiment of this invention.

FIG. 22 is an explanatory diagram showing an example of a design correspondence according to the second embodiment of this invention.

FIG. 23 is an explanatory diagram showing a configuration example of a probe definition storage module according to the second embodiment of this invention.

FIG. 24 is a block diagram showing a physical configuration of the application program monitoring system according to the first embodiment of this invention.

### DETAILED DESCRIPTION OF THE PREFERRED EMBODIMENTS

The preferred embodiments will be described below referring to the drawings.

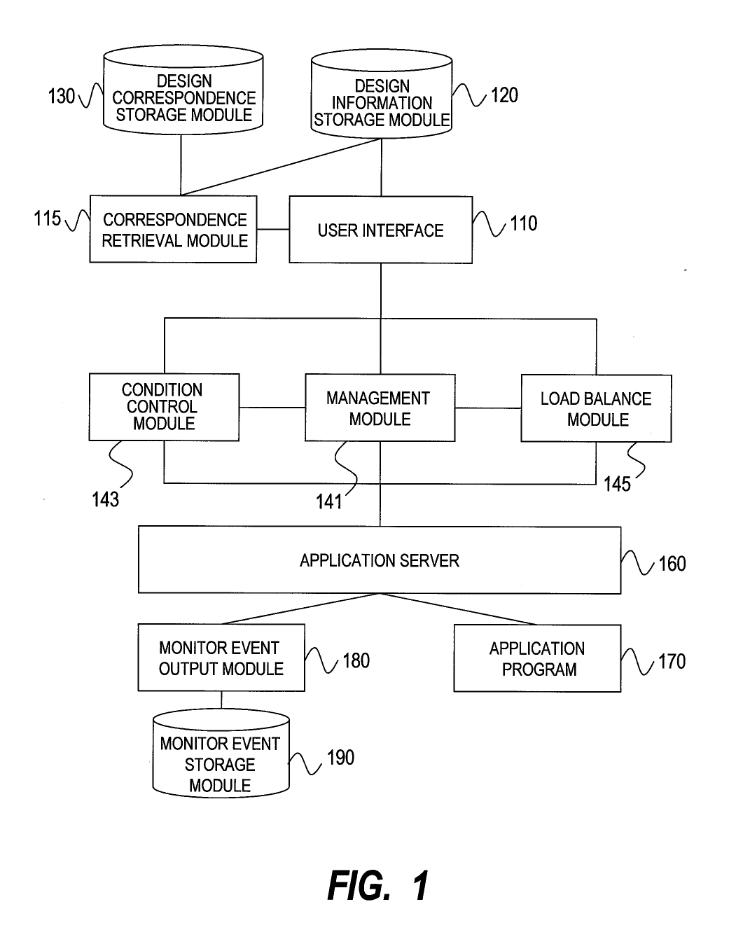

FIG. 1 is a block diagram showing a configuration of an application program monitoring system according to a first embodiment of this invention.

A publicly known application server 160 reads an application program 170 from a publicly known program storage device (not shown) to execute it. This embodiment will be described by taking an example where the application server 160 is an application server of Java 2 enterprise edition (J2EE) (Java is a registered trademark), and the application program 170 is an application program implemented by using the J2EE. According to this embodiment, the application server 160 has a function of rewriting the application program 170 to be executed by using a bytecode instrumentation technique during execution, and an interface (not shown) for controlling the rewriting function.

A user interface 110 is a user interface for setting and managing monitoring of the application program executed by the system.

A correspondence retrieval module 115 retrieves a correspondence between components of design information created in an application development process, which are stored in a design information storage module 120, by using information stored in a design correspondence storage module 130.

The design information is a generic term of model diagrams or the like used for developing the application program 170. The components of the design information are points (places), data, or the like of the design information. For example, the component of the design information may be an activity or connection flow in a business process diagram, a message in a UML sequence diagram, a class, method, or field in a class diagram, or a class, method, or field in a program code.

A management module 141 generates a program module for executing monitoring of the application program 170 in the application server 160 according to settings, and inserts the generated program module into the application program 170. The program module that executes this monitoring is called a probe.

A condition control module 143 controls a monitoring operation by the probe based on predetermined conditions.

A load balance module 145 measures and controls an influence of a load of the monitoring operation by the probe on the application program 170.

A publicly known monitor event output module 180 provides an application programming interface (API) for outputting a monitored event to the application program 170. As an example of the monitor event output module 180, there is a Java logging API or Log4J which is a logging API in Java. The monitor event output module 180 outputs a monitor event in a format designated by a user to a publicly known monitor event storage module 190. For example, the monitor event storage module 190 may be a file system, a database, or the like.

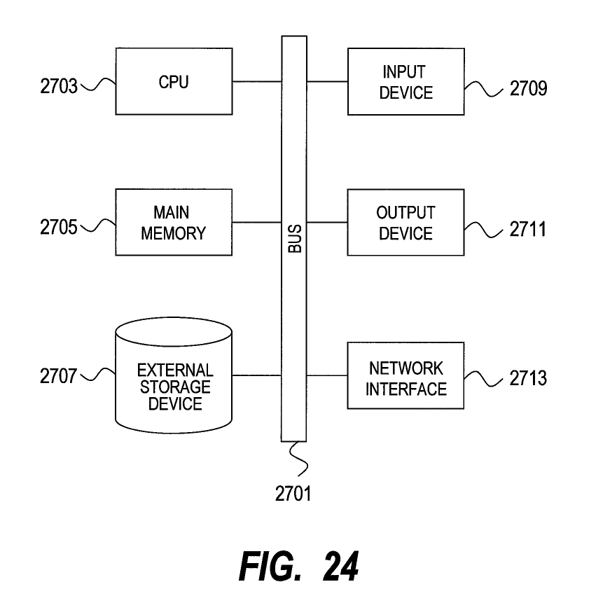

FIG. 24 is a block diagram showing a physical configuration of the application program monitoring system according to the first embodiment of this invention.

Specifically, FIG. 24 shows an example of a computer system for realizing the system shown in FIG. 1. This computer system includes a CPU 2703, a main memory 2705, an external storage device 2707, an input device 2709, an output device 2711, and a network interface 2713. The components are interconnected through a bus 2701.

The CPU 2703 is a processor for executing a program stored in the main memory 2705. In the description below, processing executed by the program stored in the main memory 2705 is actually executed by the CPU 2703.

The main memory 2705 is, for example, a semiconductor device. The main memory 2705 stores a software program read from the external storage device 2707, and information or the like referred to by the program.

The input device 2709 is, for example, a keyboard or a mouse.

The output device 2711 is, for example, a display device.

The external storage device 2707 is, for example, a hard disk device. The design information storage module 120, the design correspondence storage module 130, and the monitor event storage module 190 shown in FIG. 1 are realized as storage areas in the external storage device 2707. These modules may be implemented as, for example, databases. Further, software programs that constitute the application program monitoring system shown in FIG. 1 are stored in the external storage device 2707.

Specifically, the software programs constituting the application program monitoring system includes the user interface 110, the correspondence retrieval module 115, the management module 141, the condition control module 143, the load balance module 145, and the monitor event output module 180. These software programs are read into the main memory 2705, and executed by the CPU 2703, thereby realizing the system shown in FIG. 1. The user interface 110 executes reception of an input from the user and outputting of information to the user by using the input device 2709 and the output device 2711.

When the system shown in FIG. 1 is realized by one computer system, the external storage device 2707 further stores the application server 160 and the application program 170. In this case, the application server 160 and the application program 170 are read into the memory 2705, and executed by the CPU 2703.

The application program monitoring system shown in FIG. 1 can be realized not only by one computer system but also by a plurality of computer systems interconnected via a network interface 2713. In this case, the modules shown in FIG. 1 are separately arranged in the plurality of computer systems, and interconnected via the network interface 2713.

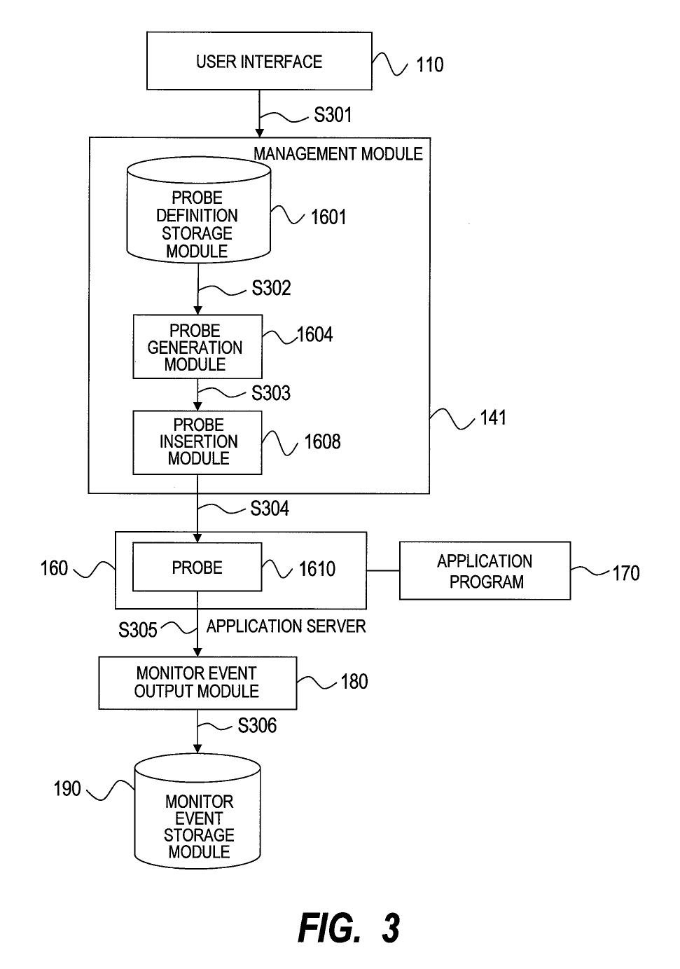

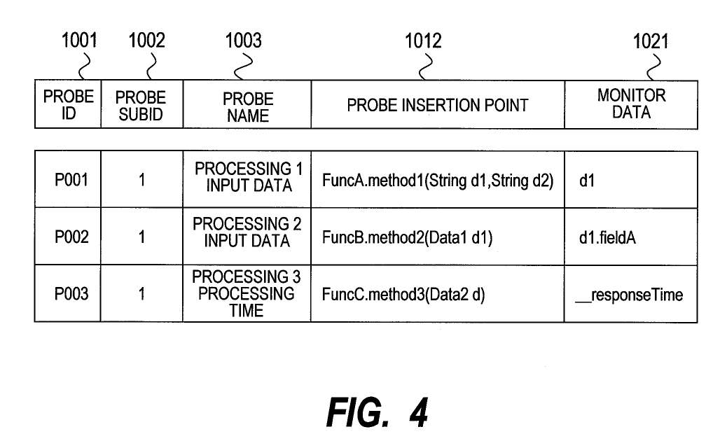

Next, referring to FIGS. 3 and 4, a flow of processing where the management module 141 shown in FIG. 1 executes monitoring of an application program based on predetermined monitoring settings of the application program will be described.

FIG. 3 is an explanatory diagram showing a configuration of the management module 141 according to the first embodiment of this invention.

The management module 141 includes a probe definition storage module 1601, a program generation module 1604, and a probe insertion module 1608. The probe definition storage module 1601 is a storage area secured in the main memory 2705 or the external storage device 2707. The probe generation module 1604 and the probe insertion module 1608 are program modules included in the management module 141. The user interface 110, the application sever 160, the application program 170, the monitor event output module 180, and the monitor event storage module 190 are the same as those shown in FIG. 1.

The application program 170 is read by the application server 160 to be executed.

The probe 1610 is a program module inserted into the application program 170 to execute monitoring of the application program 170.

The probe definition storage module 1601 stores probe definition, which is monitoring settings of the application program 170 described at a program code level. Based on the probe definition, a “place (point)” of executing monitoring in the application program and an “item” to be monitored are explicitly designated by using components of a program code.

FIG. 4 is an explanatory diagram showing a configuration example of the probe definition storage module 1601 according to the first embodiment of this invention.

The probe definition stored in the probe definition storage module 1601 contains a probe ID 1001, a probe subID 1002, a probe name 1003, a probe insertion point 1012, and monitor data 1021.

The probe ID 1001 is an ID for uniquely identifying the probe 1610, and used for identifying the probe 1610 and monitor data output from the probe 1610.

The probe subID 1002 is a serial number used for identifying a plurality of probe definitions having the same probe ID 1001. According to this embodiment, as there is only one probe definition having one probe ID, the probe subID 1002 is always “1”. Thus, according to this embodiment, the probe subID 1002 is not an essential item.

The probe name 1003 is a name given to the probe 1610.

The probe insertion point 1012 designates a place (point) of inserting the probe 1610. Specifically, the probe insertion point 1012 is designated by designating a component of the application program.

The monitor data 1021 is obtained by the probe 1610, and designates data to be output. The data obtained and output by the probe 1610 is normally obtained as a so-called application log. For example, the probe 1610 obtains and outputs data such as an I/O parameter processed by the application program 170, processing time of the application program 170, or the like, as the application log (refer to S305 of FIG. 3).

In the example of FIG. 4, probe definition of a 1st line indicates that a probe 1610 having a probe ID 1001 of “P001” is inserted into a method “FuncA.method1 (String d1, String d2)”, and a first argument “d1” of the method is obtained as monitor data. “_responseTime” designated in an item of monitor data 1021 of a 3rd line indicates processing time of the method. In other words, probe definition of the 3rd line indicates that a probe 1610 having a probe ID 1001 of “P003” is inserted into a method “FuncC.method3 (Data2 d)”, and processing time of the method is obtained as monitor data.

According to this embodiment, the probe 1610 is realized as an advice in aspect-oriented programming which is a publicly known technique. The probe insertion module 1608 inserts the probe 1610 into the application program 170 by incorporating a program code of the probe 1610 defined as the advice in the application program 170 by an aspect-oriented programming framework. A point of inserting the probe 1610 is designated by inputting a point cut created based on a probe insertion point 1012 designated by the probe definition to the aspect-oriented programming framework.

The insertion of the probe 1610 into the application program 170 can be dynamically executed by using the aspect-oriented programming framework (e.g., dynamic AOP framework) for supporting dynamic advice incorporation during execution of the application program 170. An example of the dynamic AOP framework is JBoss AOP.

By using an optional technique of dynamically updating the program code during the execution of the application program 170, a form of the probe 1610 and the insertion of the probe 1610 into the application program 170 can be realized.

The probe 1610 may be inserted while the application program 170 is not executed. However, if the probe insertion module 1608 has no function of inserting the probe 1610 during the execution of the application program 170, the entire or a part of the application program 170 must be stopped to insert or remove the probe 1610 and subsequently started again.

Next, referring to FIG. 3, a processing flow of executing monitoring of the application program 170 based on the probe definition will be described. According to a request from the outside (S301), the probe generation module 1604 of the management module 141 obtains the probe definition from the probe definition storage module 1601 (S302). This request is, for example, a request which the business or operation administrator has input by using the user interface 110. The probe generation module 1604 obtains designated data, and generates the program code of the probe 1610 for outputting the data as monitor data as an advice of aspect-oriented programming based on contents of the monitor data 1021 of the probe definition.

A publicly known automatic program code generation technique is used for generating code of the probe 1610. Specifically, the probe generation module 1604 which has received the probe insertion point 1012 and the monitor data 1021 as inputs automatically generates a program code of the probe 1610 according to the inputs. The program code generated at this time is a program code for obtaining data corresponding to the input monitor data 1021 at a point of a code of the application program 170 corresponding to the input probe insertion point 1012, and outputting the data by using the API of the monitor event output module 180 (S305 and S306).

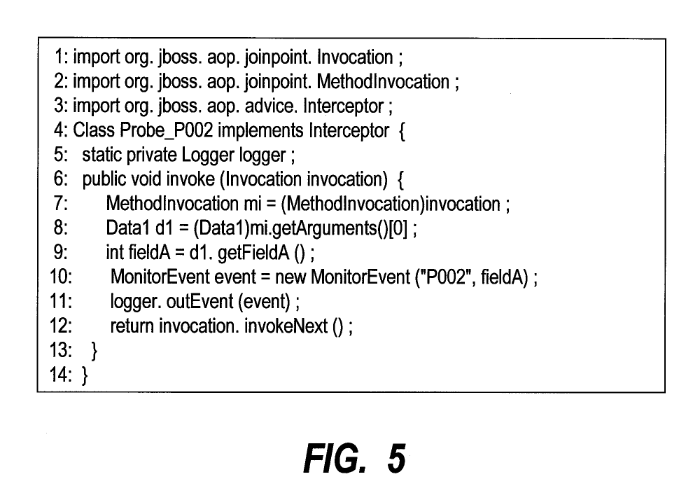

FIG. 5 is an explanatory diagram showing a code example of the probe 1610 generated as an advice according to the first embodiment of this invention.

FIG. 5 shows an example of a probe 1610 generated based on probe definition where the probe ID 1001 shown in FIG. 4 is “P002”. The probe 1610 is generated as one class of inheriting an Interceptor class by the probe generation module 1604. One probe advice is generated for one probe. A Static field logger (5th line) is an interface to the monitor event output module 180 for outputting monitor event, and set based on an initial code (not shown) executed at the time of inserting the probe 1610.

A method invoke of a probe advice is a code for executing monitoring of the application program. The code of the invoke method is inserted into a designated point of the application program 170 by the Dynamic AOP framework (S304).

According to the invoke method, first, an object of a first argument of the method into which the probe has been inserted is obtained (8th line). A value of a specific field is obtained from the object (9th line), and monitor data designated in the probe definition is obtained. Then, a monitor event object event to be output is generated (10th line). A probe ID is set in the monitor event object. This probe ID is used for identifying the monitor data. The generated event object is output to the monitor event output module 180 by using the logger interface (11th line). Subsequently, processing of the method main body into which the probe 1610 has been inserted is executed (12th line).

The probe insertion module 1608 dynamically inserts the probe 1610 generated by the probe generation module 1604 into the application program 170 by the Dynamic AOP framework (refer to S303 and S304 of FIG. 3). A point cut designating an insertion position of the probe 1610 is generated based on the probe insertion point 1012 of the probe definition. For example, in the probe definition shown in FIG. 4, a point cut designating the insertion position of the probe 1610 having the probe ID of “P002” is “execution (*FuncB->method2 (Data1))”.

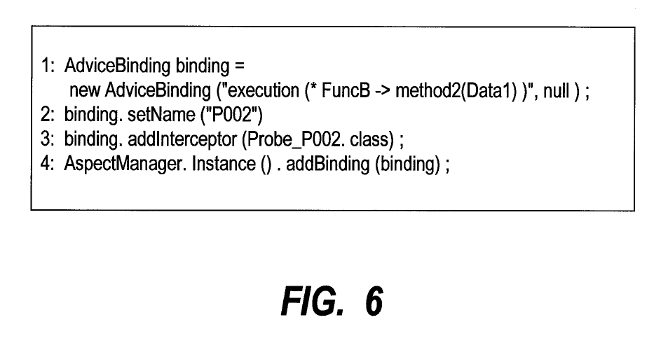

To insert the probe 1610, the probe insertion module 1608 provides the class object, the point cut, and the probe ID of the probe aspect which have been generated to an aspect administrator provided by the JBoss AOP (refer to FIG. 6).

FIG. 6 is an explanatory diagram showing an example of a program code for adding the probe 1610 to the application program 170 according to the first embodiment of this invention.

FIG. 6 shows a program code generated by the probe insertion module 1608 to insert a probe 1610 shown in FIG. 5 into the application program 170. A procedure of processing executed by the program code of FIG. 6 will be described below.

First, an AdviseBinding object “binding” of a point cut designating a position of inserting the probe 1610 is generated (1st line).

A probe ID is set as a name of the generated AdviseBinding object (2nd line), and a class of a probe advice is set (3rd line).

Then, this AdviseBinding object is registered in the aspect manager (4th line).

The aspect manager inserts the program code of the probe advice by rewriting the bytecode of the application program 170 according to the point cut and the advice class set in the registered AdviseBinding object.

The probe insertion module 1608 can remove the probe 1610 inserted into the application program 170 from the same by using the function of the Dynamic AOP framework in response to a request from the outside. The removal of the probe 1610 is executed by loading a removeBinding method of the aspect manager as an ID argument of the probe 1610 to be removed. The aspect manager removes the program code of the advice set in the AdviseBinding object where the probe ID supplied as the argument is a name by rewriting the bytecode of the application program 170.

Next, description will be made of a flow of processing where the correspondence retrieval module 115 retrieves a point of the program code, in other words, a probe insertion point of the probe definition, corresponding to designation of a “monitoring execution point” of the design information by using a design correspondence.

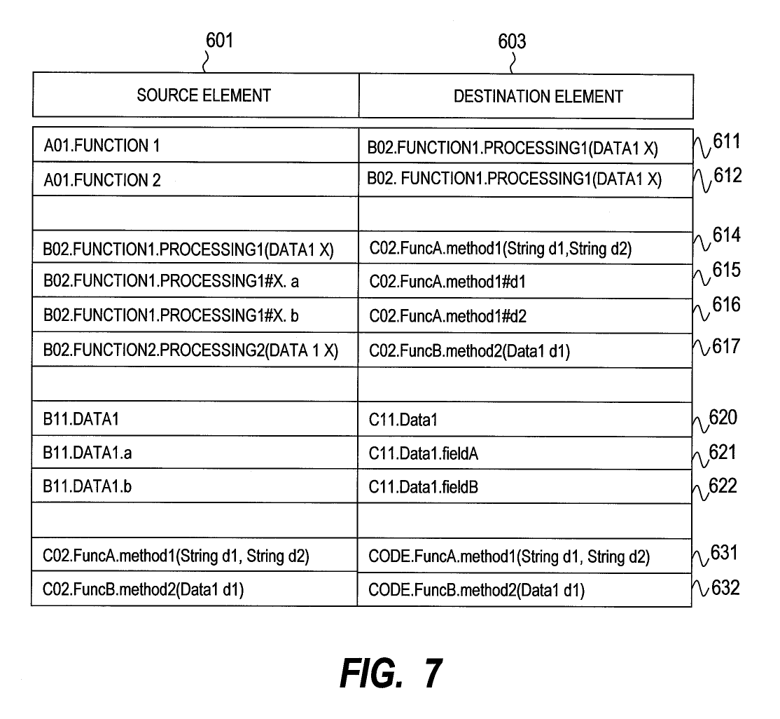

First, referring to an example of FIG. 7, the design correspondence will be described.

FIG. 7 is an explanatory diagram showing an example of a design correspondence according to the first embodiment of this invention.

The design correspondence is stored in the design correspondence storage module 130. The design correspondence includes a correspondence source element 601 and a correspondence destination element 603. Components of design information created at an optional stage of the application program development process are stored in the correspondence source element 601. Components set in design correspondence to the components stored in the correspondence source element 601 are stored in the correspondence destination element 603. The components set in design correspondence are components of design information created at a more progressed stage of the development process. For example, as a design correspondence 611 of FIG. 7, a correspondence source element 601 “A01.Function1” and a correspondence destination element 603 “B02.Function1.Processing1(data 1X)” are stored. This means that the component “A01.Function1” at a certain stage of the development process becomes a component “B02.Function1.Processing1(data 1X)” at a progressed stage of the development process.

One or more components may have a design correspondence to one component. This embodiment will be described by way of case where only one component corresponds to one component. A case where a plurality of components corresponds to one component will be described in a second embodiment.

To specify optional components in a plurality of pieces of design information, and to represent a design correspondence between the components, an ID for unique identification is added to each component of the design information. This ID is stored as design correspondence information. According to this embodiment, this ID is called an object ID.

According to this embodiment, the object ID includes an ID of design information containing a component which it identifies, and an ID of each component. For example, in the example of FIG. 7, the object ID “A01.Function1” of the correspondence source element 601 of the design correspondence 611 indicates an activity element which represents the function 1 present in a business process diagram where an ID is A01. The ID of the design information is represented by an alphabet (e.g., A) indicating a stage of the development process of the application program 170, and a serial number (e.g., 01) of the design information at each stage.

The object ID is required only to uniquely identify a component of the design information. It is only necessary to specify the design information containing the designated component from the object ID. Accordingly, a part of the object ID should preferably contain an ID of the design information.

FIG. 7 shows a design correspondence regarding two activity elements (Functions 1 and 2) of a business process diagram of a stage A for the application program 170 developed by using pieces of design information of three stages of A to C. Specifically, the design correspondence information of the example of FIG. 7 stores a design correspondence of processings (methods) (611, 612, 614, 617, 631, and 632), a design correspondence of input data of prcessings (615 and 616), and a design correspondence of data structures used for input data of processings (620 to 622).

An object ID of each input data is used for showing a design correspondence of input data of processings. The object ID of the input data is configured by concatenating a processing name with a representation of the input data. For example, a design correspondence 615 indicates that input data “X.a” of a method “Function1.Processing1” in design information B02 corresponds to input data d1 of a method “FuncA.method1” in design information C02.

Design correspondences 631 and 632 indicate that components of the design information C02 correspond to specific methods of the implemented application program 170.

According to this invention, generation of design correspondence information and its storage in the design correspondence information storage module 130 can be carried out by an optional method. However, proper design correspondence information must be stored beforehand for each design information created in the development process of the application program 170.

The generation of design correspondence information and the storage thereof in the design correspondence information storage module 130 should preferably be executed for each creation of design information of a progressed stage of the development process in the development process of the application program 170. Thus, an application design tool used for the development process of the application program 170 should preferably include a function of executing generation and storage of design correspondence information.

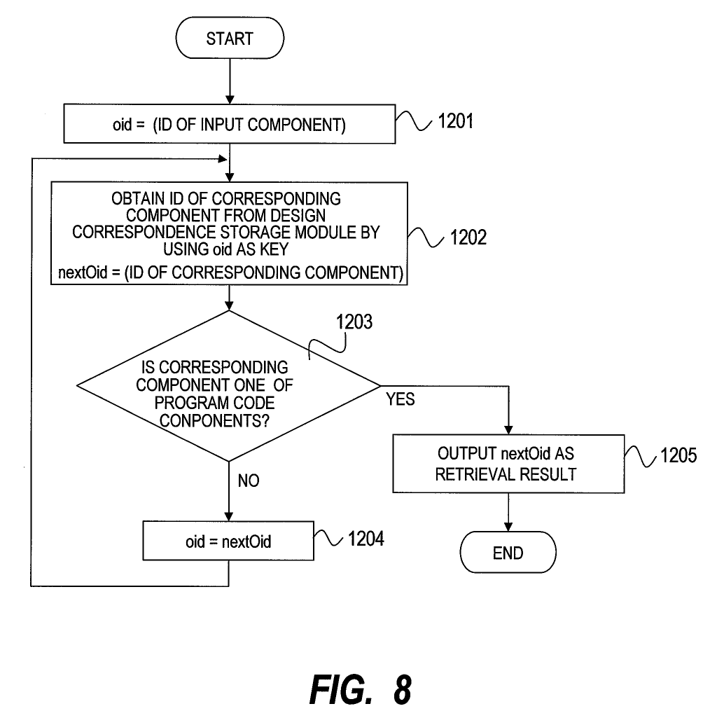

Next, referring to FIG. 8, description will be made of a flow of processing where a point of inserting a probe for executing designated monitoring is retrieved from a designated “monitoring point (i.e., a point of a monitoring target)” of the design information at a program code level by using the stored design correspondence.

FIG. 8 is a flowchart of processing where the correspondence retrieval module 115 retrieves a point of inserting the probe 1610 according to the first embodiment of this invention.

In the description of FIG. 8, the example of the design correspondence shown in FIG. 7 is used.

The user (e.g., the business or operation administrator) designates a component of design information, thereby designating a monitoring point. An object ID of the designated component is input to the correspondence retrieval module 115.

First, in a step 1201, the correspondence retrieval module 115 initializes a variable “oid” based on the input object ID.

In a step 1202, the correspondence retrieval module 115 accesses the design correspondence storage module 130 by using the oid as a key to retrieve a design correspondence where the oid is a correspondence source element 601. The correspondence retrieval module 115 stores an object ID stored in a correspondence destination element 603 of the design correspondence obtained as a result of this retrieval in a variable “nextOid”.

In a step 1203, the correspondence retrieval module 115 judges whether the nextOid is a special object ID indicating a correspondence to a component of an implemented program code of the application program 170. The component of the implemented program code is, for example, a specific method or the like.

If it is judged in the step 1203 that the nextOid is a special ID for identifying the component of the implemented program code of the application program 170, the retrieved component corresponds to the specific method or the like. In this case, the process proceeds to a step 1205, and the correspondence retrieval module 115 outputs the program code component indicated by the nextOid as a retrieval result to finish the process.

On the other hand, if it is judged in the step 1203 that the nextOid is not a special ID for identifying the component of the implemented program code of the application program 170, the component of the implemented program code corresponding to the designated component has not been retrieved. In this case, the correspondence retrieval module 115 updates the oid based on a value of the retrieved nextOid in a step 1204, and returns to the step 1202.

By repeating the process of the steps 1202 to 1204, components of design information of stages of the development process are gradually retrieved from the components of initial highly-abstract design information of the development process, and the component of the program code is retrieved at the end.

As an example, a case is explained where the activity “Function1” of the business process diagram “A01” in the example of the design correspondence of FIG. 7 is designated as a monitoring point. In this case, “A01.Function1” which is its object ID becomes an initial value of the oid (step 1201). Then, the correspondence retrieval module 115 repeatedly executes the steps 1202 to 1204 to sequentially retrieve design correspondences.

As a result of the retrieval, “B02.Function1.Processing1(data 1X)” corresponding to the “A01.Function1” is obtained (correspondence 611), “C02.FuncA.method1 (String d1, String d2)” corresponding to the “B02.Function1.Processing1 (data 1X)” is obtained (correspondence 614), and “CODE.FuncA.method1(String d1, String d2)” corresponding to the “C02.FuncA.method1(String d1, String d2)” is obtained (correspondence 631).

As the “CODE.FuncA.method1(String d1, String d2)” is a component of the program code (step 1203), it is retrieved that the method “FuncA.method1(String d1, String d2)” is a component of the program code corresponding to the function 1 (step 1205). By inserting the probe 1610 into this method, monitoring of the “Function1” is executed. When a target to be monitored at the designated point does not necessitate generation of each probe to be inserted, the designated monitoring is executed by inserting a probe advice prepared beforehand into the retrieved point of the program code. The monitoring target that does not necessitate generation of each probe to be inserted is, for example, processing time.

Through the aforementioned processing, a point of the program code corresponding to the designated “monitoring point” of the design information is retrieved by using the stored design correspondence. Then, monitoring of the retrieved point is executed. As a result, without awareness of the implemented program code, designation of monitoring of the application program 170 in the design information created in the development process of the application program is realized.

FIG. 8 shows the processing of the correspondence retrieval module 115 when the “monitoring point” is designated in the design information. However, optional data of the design information may be designated as “data to be monitored (data of a monitoring target)”. The optional data of the design information is data to be processed in the business process, for example, an I/O parameter of certain processing. Next, a flow of processing executed by the correspondence retrieval module 115 when the “data to be monitored” is designated in the design information will be described. In this case, the correspondence retrieval module 115 refers to the design correspondence to retrieve a component of the program code corresponding to the designated “data to be monitored”, i.e., monitor data 1021 in probe definition.

The retrieval of the “data to be monitored” is executed by the same processing as that of the “monitoring point”.

The design correspondence includes not only a correspondence of “processing” between pieces of design information but also correspondences of “data structure” and “I/O parameter”. For example, in FIG. 7, the design correspondences 615 and 616 indicate correspondences of input parameters of processings set in design correspondence. The design correspondence 615 indicates that a field “a” of an input parameter “X” of Processing 1 corresponds to a first argument of the method “method1” corresponding to the Processing 1.

Design correspondences 620 to 622 indicate correspondences between a data structure “data 1” and fields of a data structure “Data1”.

For example, when in the class diagram “B02” of a certain stage of the development process of the application program, for the I/O parameter “X” of the method “Processing 1” of the class “function 1”, its field “b” is designated to be monitored, the operation or business administrator provides an object ID “B02.Function1.Processing1#X.b” as an input to the correspondence retrieval module 115. Thereafter, by tracing the design correspondences according to the flow of FIG. 8, in the implemented program, a correspondence of a second argument “d2” of the method “method1” of the class “FuncA” to the designated data to be monitored is retrieved. In the case of this example, a monitoring point is designated simultaneously with the data to be monitored. Thus, through retrieval, a point of inserting a probe and data to be obtained by the probe are both decided, and designated monitoring is executed.

The design correspondence storage module 130 may store design correspondences of all components which can be designated as points of executing monitoring and data to be monitored. However, if another design correspondence can be inferred by combining data regarding a plurality of deign correspondences or pieces of design information, it is possible to reduce costs of storing the design correspondences by omitting storage of the inferable design correspondences.

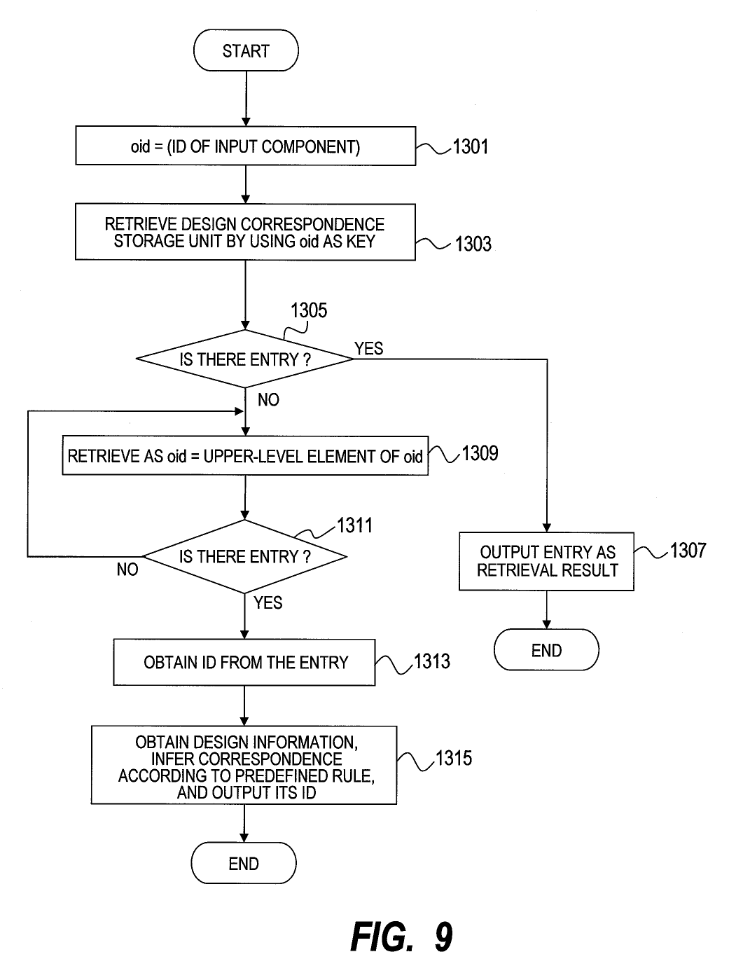

The example of the design correspondence 617 of FIG. 7 indicates that the input parameter “X” in processing of a correspondence source corresponds to an input parameter “d1” of processing of a correspondence destination. However, a design correspondence for each field of the input parameter “X” is not stored. However, by using the design correspondences 620 to 622 of “B11.data1” which is a data structure of the input parameter “X” and “C11.Data1” which is a data structure of the input parameter “d1”, it is possible to infer design correspondences which have not been stored. Referring to FIG. 9, a flow of this processing will be described.

FIG. 9 is a flowchart of processing where the correspondence retrieval module 115 infers the design correspondence according to the first embodiment of this invention.

This processing corresponds to the processing of the step 1202 in the flow of specifying the program code component by using the design correspondence shown in FIG. 8.

First, in a step 1301, the correspondence retrieval module 115 stores the input object ID in the variable “oid”. In the example, as the object ID, “B02.Function2.Processing2#X.a”, i.e., a field “a” of a parameter “X” of “processing 2”, is input.

In a step 1303, the correspondence retrieval module 115 accesses the design correspondence storage module 130 by using the oid as a key to retrieve a design correspondence where the oid is a correspondence source element 601.

Then, in a step 1305, the correspondence retrieval module 115 judges whether a design correspondence regarding the oid is present. Specifically, judgment is made as to whether the design correspondence where the correspondence source element 601 is the oid has been stored in the design correspondence storage module 130.

If it is judged in the step 1305 that the design correspondence regarding the oid is present, the process of the correspondence retrieval module 115 proceeds to a step 1307.

In the step 1307, the correspondence retrieval module 115 outputs a correspondence destination element 603 of the retrieved design correspondence as a retrieval result to finish the process.

If it is judged in the step 1305 that the design correspondence regarding the oid is not present, the process of the correspondence retrieval module 115 proceeds to a step 1309. For example, if the oid is “B02.Function2.Processing2#X.a”, a design correspondence where the oid is held as the correspondence source element 601 is not present. In this case, the process proceeds to a step 1309.

In the step 1309, the correspondence retrieval module 115 specifies an upper-level component of components designated by the oid. For example, if the oid is “B02.Function2.Processing2#X.a”, “B02.Function2.Processing2#X” obtained by removing the field “a” is an upper-level component. In this case, the correspondence retrieval module 115 retrieves a design correspondence by using the “B02.Function2.Processing2#X” as a new oid in place of the “B02.Function2.Processing2#X.a”.

Then, in a step 1311, the correspondence retrieval module 115 judges whether a design correspondence regarding the oid (i.e., upper-level component specified in the step 1309) has been stored. This judgment is executed as in the case of the step 1305.

If it is judged in the step 1311 that the design correspondence regarding the oid has not been stored, the correspondence retrieval module 115 returns to the step 1309 to specify and retrieve a further upper-level component.

If it is judged in the step 1311 that the design correspondence regarding the oid has been stored, the correspondence retrieval module 115 proceeds to a step 1313.

In the step 1313, the correspondence retrieval module 115 obtains a component set in design correspondence to the upper-level component. For example, if the upper-level component is “B02.Function2.Processing2#X”, this component is processing “B02.Function2.Processing2” which has one parameter X. This corresponds to “B02.Function2.Processing2(data 1X)” which is a correspondence source element of the design correspondence 617, and the design correspondence 617 regarding this has been stored. In this case, “C02.FuncB.method2#d1” is obtained as a component corresponding to the upper-level component.

In a step 1315, the correspondence retrieval module 115 infers a design correspondence of a lower-level component based on the design correspondence of the upper-level component retrieved in the step 1313. For example, if the “C02.FuncB.method2#d1” is obtained in the step 1313, the correspondence retrieval module 115 retrieves a design correspondence of its field “a” for a data structure “B11.data1” of the parameter “X”. As a result, a correspondence of “fielda” in a data structure “C11.Data1” of a parameter “D1” is retrieved (refer to the design correspondence 621). Accordingly, the correspondence retrieval module 115 infers “C02.FuncB.method2#d1.fieldA” as a component set in design correspondence to the “B02.Function2.Processing2#X.a”, and outputs it as a retrieval result of the design correspondence.

The specifying of the upper-level component and the inference of the design correspondence based on the same in the above-mentioned flow are executed according to a rule defined beforehand according to design information where the component is present, and a type of the component. According to this rule, it is possible to reduce storage costs by omitting a part of the design correspondence information stored in the design correspondence storage module 130.

Next, the user interface 110 shown in FIG. 1 will be described.

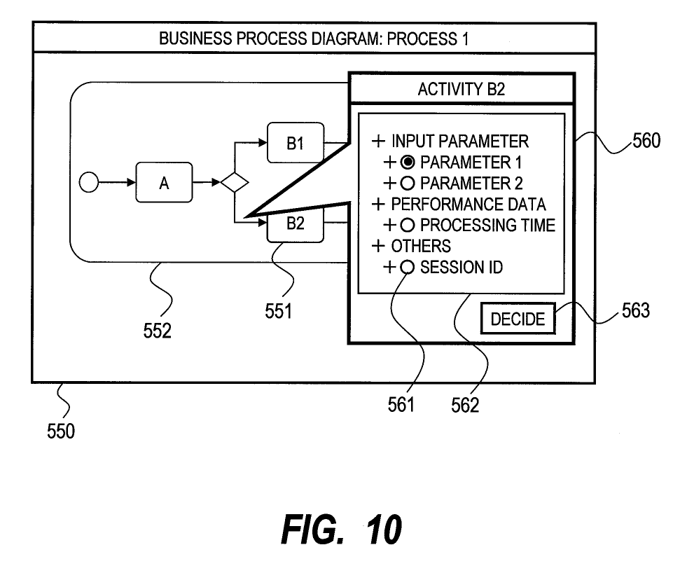

FIG. 10 is an explanatory diagram showing an example of the user interface 110 for executing monitoring setting of the application program 170 in the design information according to the first embodiment of this invention.

The user interface 110 of FIG. 10 enables the user (e.g., operation or business administrator) to input a point (monitoring point) of executing monitoring and data (monitor data) of a monitoring target of the application program 170 in design information created at certain design stage of the application program development.

A design information display window 550 displays design information where the user inputs contents to be monitored. The user selects a component 551 of design information 552 displayed on the window by an operation such as clicking of the component to designate a monitoring point.

Upon designation of the monitoring point, the user interface 110 displays a list 562 of items that can be monitored at the designated monitoring point on a monitor data selection window 560. The user can select data to be monitored at the designated monitoring point by checking a radio button 561 corresponding to each data item displayed in the item list 562.

After the selection of the monitor data, the user operates a decide button 563 to decide the designated monitoring point and the monitor data, and retrieval is executed by the correspondence retrieval module 115.

If data not unique to the monitoring point, for example, processing time or the like, is designated as the monitor data, the retrieval of the correspondence retrieval module 115 is executed by using an object ID of the designated monitoring point as a key (refer to FIG. 8). Then, a retrieved component of the program code is stored in a probe insertion point 1012 of generated probe definition. In monitor data 1021 of the probe definition, a symbol predefined to indicate the selected monitor data such as processing time is stored.

If the designated monitor data is an I/O parameter or the like unique to the monitoring point, the retrieval of the correspondence retrieval module 115 is executed by using an object ID indicating its data as a key (refer to FIG. 8). As a result, a component of the program code to be retrieved has information of both of a point of the program code corresponding to the designated monitor point and data to be treated at the point. Accordingly, according to the retrieved component, the point of the program code corresponding to the monitor point is stored in the generated probe insertion point 1012 of the probe definition to be generated, and the data treated at the point is stored in the monitor data 1021.

When storing the probe definition, the user interface 110 displays an interface for enabling the user to input a name to be added to the input monitoring setting. Then, the user interface 110 stores the input name in a probe name 1003 of the probe definition. The user interface 110 generates an ID for uniquely identifying the probe definition, and stores the ID as an ID 1001 of the probe definition.

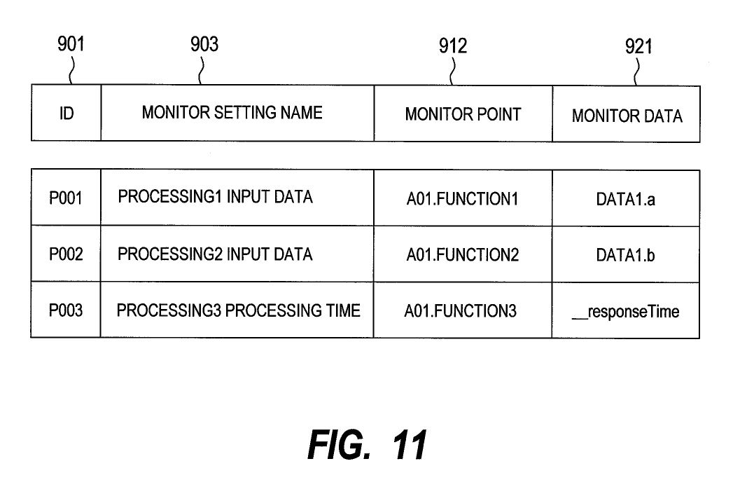

FIG. 11 is an explanatory diagram showing an example of a monitoring setting table according to the first embodiment of this invention.

The monitoring setting table is a table for managing the monitoring setting input by the user and the probe 1610 generated based on the input monitoring setting. The monitoring setting table may be a part of the user interface 110, or a part of one of the storage modules (e.g., design information storage module 120) accessed by the user interface 110. In any case, the monitoring setting table is stored in the main memory 2705 or the external storage device 2707.

An ID for uniquely identifying each monitoring setting is stored in an ID 901.

A name added to monitoring setting is stored in a monitor setting name 903.

An object ID of an input monitoring place is stored in a monitoring point 912.

An object ID for input monitor data or a symbol of a predefined monitor data item is stored in monitor data 921. The symbol of the predefined monitor data item is, for example, “_responseTime” or the like.

The ID 901 and the monitor setting name 903 of the monitor setting table store the same as those of the ID 1001 and the probe name 1003 of the generated probe definition. By using the same ID in the monitoring setting and the probe definition, the monitoring setting and the probe definition are correlated with each other.

The user interface 110 refers to pieces of information on the monitoring point 912 and the monitor data 921 stored in the monitor setting table to display information of the set probe 1610, and enables the user to select it.

For example, when the user operates a screen shown in FIG. 10 to designate monitoring of data corresponding to monitor data “data 1.a” at a place corresponding to a monitor point “A01.Function1”, the “A01.Function1” is stored in the monitor point 912 of the monitoring setting table, and the “data 1.a” is stored in the monitor data 921. Further, in the ID 901 and the monitor setting name 903, pieces of information for identifying the monitoring point and the like are stored. In the example of FIG. 11, “P001” and “Processing 1 input data” are stored as the ID 901 and the monitor setting name 903 for identifying the monitoring point “A01.Function1” and the monitor data “data 1.a” (refer to 1st row of FIG. 11).

In this case, the correspondence retrieval module 115 executes processings shown in FIGS. 8 and 9. In this case, the “A01.Function1” and the “data 1.a” are input. As a result, for example, “FuncA.method1(String d1, String d2)” and “d1” are obtained as a probe insertion point and monitor data. In this case, as in the case of the monitoring setting table, “P001” and “Processing 1 input data” are stored as an ID 1001 and a probe name 1003 of the probe definition storage module 1601. Then, “FuncA.method1(String d1, String d2)” and “d1” obtained as a result of retrieval are stored as a probe insertion point 1012 and monitor data 1021 (refer to 1st row of FIG. 4).

As design information displayed on the design information display window 550 to designate a monitoring point and monitor data, optional design information created at an optional stage of the application development process according to an input from the user can be used. In this case, design information containing a component set in design correspondence with a component of the displayed design information may be retrieved by using design correspondence information, the retrieved design information may be displayed as a candidate of design information to be displayed, and the user may select one of the displayed candidates.

The user interface 110 may include a user interface for inputting a monitoring definition ID to be added to monitor definition to be set and a value of a monitor item ID added to each monitor item set in the monitor definition in setting of the monitor definition. Alternatively, the user interface 110 may automatically generate a monitor definition ID and a monitor item ID to set them.

A configuration of the user interface 110 and an input procedure for monitoring setting are not limited to the examples of this embodiment. It is possible to use any interface that can input a monitoring point, and an item to be monitored at the monitoring point, and a monitor definition ID and a monitor item ID if necessary.

As described above, by using the system shown in FIG. 1, if the user sets monitoring of the application program to be executed in the design information of certain stage of the development process of the application program, a correspondence between input setting and the implemented program is automatically executed without any human labor. Thus, it is possible to immediately execute the set monitoring of the application program.

Next, a configuration and an operation of a system for controlling a monitoring operation of the probe 1610 inserted into the application program 170 according to designated conditions will be described.

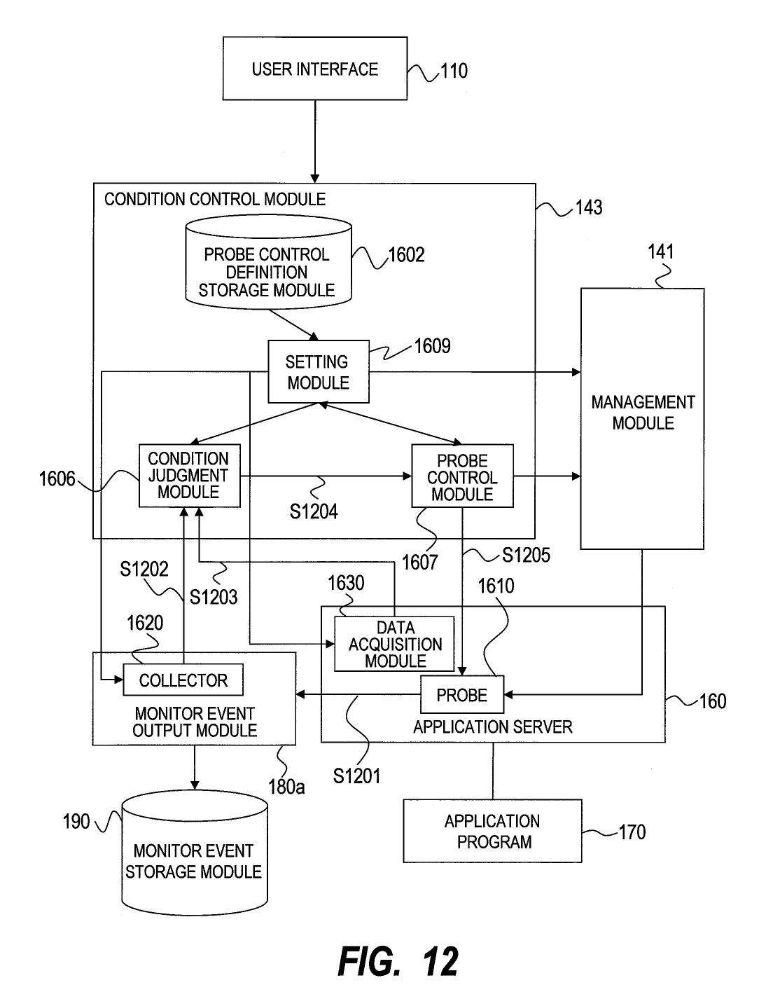

FIG. 12 is a block diagram showing a configuration of the system for controlling the monitoring operation of the probe 1610 according to the first embodiment of this invention.

A condition control module 143 includes a probe control definition storage module 1602, a setting module 1609, a condition judgment module 1606, and a probe control module 1607. A management module 141 is the same as that shown in FIG. 3.

The probe control definition storage module 1602 is a storage area secured in the main memory 2705 or the external storage device 2707. The condition judgment module 1606, the probe control module 1607, and the setting module 1609 are program modules included in the condition control module 143.

The probe 1610 is a program module inserted into the application program 170 by the management module 141 shown in FIG. 3. One or more probes 1610 may be inserted into the application program 170.

A monitor event output module 180a is formed by adding a collector 1620 to the publicly known monitor event output module 180 shown in FIG. 1.

The collector 1620 is a program module for obtaining data output from the probe 1610 and transferring the data to the condition judgment module 1606 if necessary.

A data acquisition module 1630 is a program module arranged in the application server 160 or the like to obtain state monitor data and external information. FIG. 12 shows an example where the data acquisition module 1630 is arranged in the application server 160.

The data acquisition module 1630 obtains information other than data monitored by the probe 1610. Specifically, for example, the data acquisition module 1630 obtains state monitor data of the application program 170, the application server 160, an OS and hardware for executing the application server 160, or a system itself for monitoring the application program. For example, the data acquisition module 1630 may obtain a load of the CPU 2703 as state monitor data.

The data acquisition module 1630 may obtain external information such as time in addition to the stage monitor data.

The probe control definition storage module 1602 stores probe control definition. The probe control definition is information for designating conditions for controlling the monitoring operation of the probe 1610 inserted into the application program 170, and an operation for controlling the monitoring operation of the probe 1610. The monitoring operation of the probe 1610 is, for example, acquisition or outputting of monitor data.

Based on this probe control definition, the setting module 1609 sets each module to control the monitoring operation of the probe 1610.

First, a flow of processing for controlling the monitoring operation of the probe 1610 based on the probe control definition will be described.

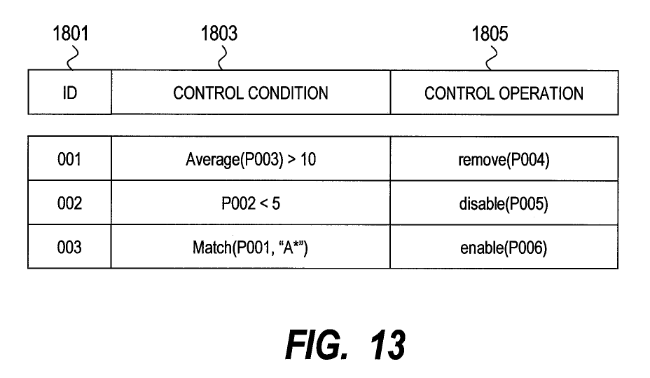

FIG. 13 is an explanatory diagram showing a configuration example of the probe control definition storage module 1602 according to the first embodiment of this invention.

The probe control definition stored in the probe control definition storage module 1602 contains an ID 1801, a control condition 1803, and a control operation 1805. The ID 1801 identifies each probe control definition. The control condition 1803 designates a condition for controlling the monitoring operation of the probe 1610. The control operation 1805 designates an operation for controlling the monitoring operation of the probe 1610.

The control of the monitoring operation of the probe 1610 is described in an IF-THEN format. Specifically, an IF part corresponds to the control condition 1803, and a THEN part corresponds to the control operation 1805. In other words, when a condition stored in the control condition 1803 is satisfied, an operation stored in the control operation 1805 is executed.

The control condition 1803 is described in a conditional equation which includes data used for condition judgment. As the data used for condition judgment, monitor data obtained by the probe 1610 inserted into the application program 170 can be designated. Alternatively, information obtained by the data acquisition module 1630 prepared beforehand in the system may be used.

The data used for the condition judgment are called judgment information. Each judgment information is identified by a unique ID. The conditional equation representing the control condition is described by using the ID of the judgment information. When the monitor data obtained by the probe 1610 is used as judgment information, the probe ID 1001 of the probe definition shown in FIG. 4 becomes an ID of judgment information. The data obtained by the data acquisition module 1630 is designated by a special ID provided beforehand.

The control operation 1805 stores a control method executed when the control condition 1803 is satisfied, and the probe 1610 whose monitoring operation is controlled by this method. Further, a control parameter is stored if necessary.

The method of controlling the monitoring operation of the probe 1610 is, for example, a start or a stop of the monitoring operation of the probe 1610. Alternatively, the monitoring operation of the probe 1610 may be controlled by executing acquisition and outputting of monitor data at a predetermined interval set based on time or the number of times of executing the application program 170.

The probe insertion module 1608 inserts the probe 1610 into the application program 170 or removes the probe from the application program 170, whereby the start or the stop of the monitoring operation of the probe 1610 can be executed. Alternatively, an operation control code (not shown) for controlling the execution of the monitoring operation of the probe 1610 may be incorporated, and a variable may be allocated to control the operation control code. This variable is called an operation control variable. The operation control code refers to the operation control variable to judge permission/inhibition of execution of the monitoring operation, whereby the monitoring operation of the probe can be controlled (disabled or enabled). The operation control variable is stored in a memory area accessed from both of the probe 1610 and the probe control module 1607.

The 1st row of FIG. 13 indicates that a probe having an ID of P004 is removed from the application program 170 when an average value of a predetermined period of the monitor data of the probe 1610 having an ID of P003 exceeds 10. The 2nd row indicates that an operation of a probe P005 is disabled when a value of monitor data of a probe P002 drops below 5. The 3rd row indicates that an operation of a probe P006 is enabled when a value of a probe P001 is a character string starting from A.

A flow of processing for controlling the monitoring operation of the probe 1610 by the system will be described.

First, according to execution of the application program 170, the probe 1610 inserted into the application program 170 outputs monitor data (S1201). The output monitor data is output via the monitor event output module 180a. At this time, the collector 1620 of the monitor event output module 180a judges whether the monitor data is data used as judgment information. If it is judged that the monitor data is data used as judgment information, the monitor event output module 180a transfers the monitor data to the condition judgment module 1606 (S1202).

On the other hand, if judgment information is data other than the monitor data of the probe 1610, the data acquisition module 1630 periodically obtains data, and transmits the obtained data to the condition judgment module 1606 (S1203). Alternatively, the condition judgment module 1606 may obtain data to be used as judgment information by periodically calling the data acquisition module 1630.

The condition judgment module 1606 evaluates a conditional equation stored in the control condition 1803 by using the judgment information obtained from the collector 1620 or the data acquisition module 1630, and transmits an evaluated result to the probe control module 1607 (S1204). The probe control module 1607 controls the monitoring operation of the probe 1610 by executing the operation stored in the control operation 1805 according to a result of condition judgment received from the control judgment module 1606 (S1205).

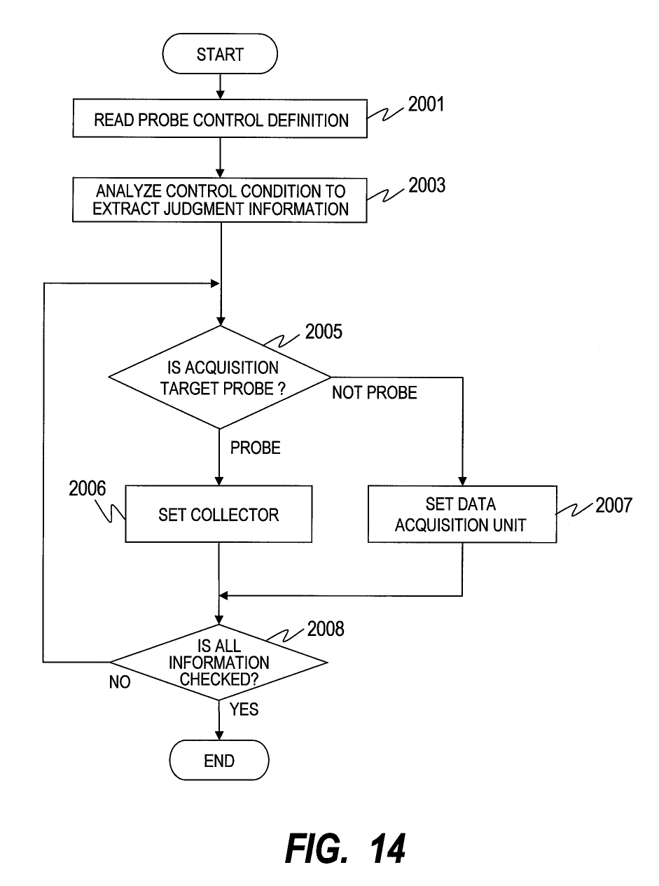

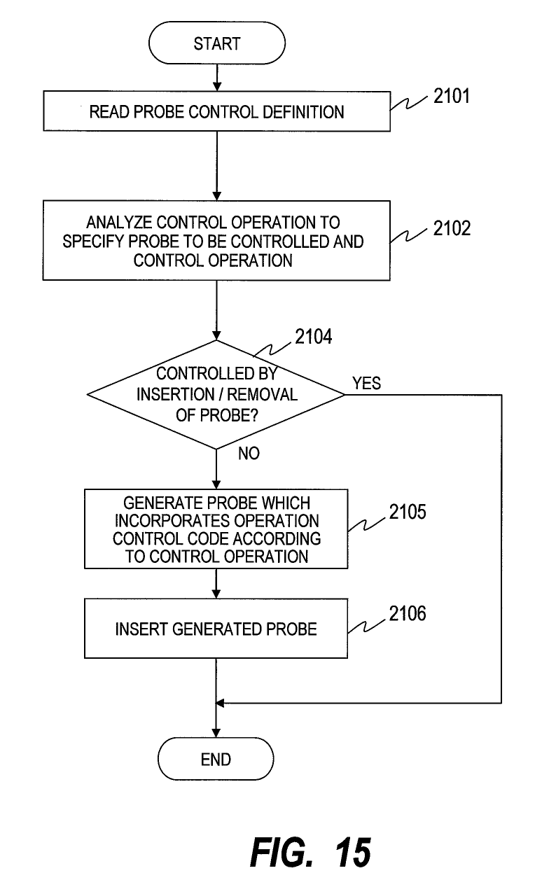

Next, referring to FIGS. 14 and 15, description will be made of a flow of processing where the setting module 1609 sets the condition judgment module 1606 and the probe control module 1607 to execute control of the monitoring operation of the probe 1610 based on the probe control definition.

FIG. 14 is a flowchart of processing where the setting module 1609 sets the condition judgment module 1606 according to the first embodiment of this invention.

The setting module 1609 sets the condition judgment module 1606 by executing the flow of FIG. 14 based on the probe definition.

First, in a step 2001, the setting module 1609 obtains probe control definition from the probe control definition storage module 1602.

In a step 2003, the setting module 1609 analyzes the control condition 1803 of the probe control definition to extract designation of judgment information.

Then, the setting module 1609 executes processing of steps 2005 to 2008 for all the pieces of judgment information extracted in the step 2003.

In the step 2005, the setting module 1609 judges whether data is data obtained by the probe 1610 based on an ID of data designated as judgment information. If it is judged in the step 2005 that the designated data is data obtained by the probe 1610, the process proceeds to the step 2006. On the other hand, if it is judged in the step 2005 that the designated data is not data obtained by the probe 1610, the process proceeds to the step 2007.

In the step 2006, the setting module 1609 registers an ID of the designated data in the collector 1620 of the monitor event output module 180a.

In the step 2007, the setting module 1609 specifies a data acquisition module 1630 which obtains data based on the ID of the data designated as the judgment information, and sets the specified data acquisition module 1630 to obtain data.

After the execution of the step 2006 or 2007, in the step 2008, the setting module 1609 judges whether processing of all the pieces of judgment information extracted in the step 2003 has been completed.

If it is judged in the step 2008 that the processing has been completed for all the pieces of judgment information, the setting module 1609 finishes the process. On the other hand, if it is judged in the step 2008 that the processing has not been completed for all the pieces of judgment information, there is unprocessed judgment information. In this case, to process the unprocessed judgment information, the setting module 1609 returns to the step 2005.

The collector 1620 judges whether an ID added to the monitor data is an ID registered in the step 2006 when the probe 1610 obtains the monitor data and outputs it via the monitor event output module 180a. If it is judged that the ID has been registered, the collector 1620 transmits the monitor data to the condition judgment module 1606.

The condition judgment module 1606 interprets and executes a condition judgment equation described as the control condition 1803 by using a value of the judgment information. Specifically, a publicly known interpreter disposed in the condition judgment module 1606 may interpret and execute the condition judgment equation. Alternatively, a program module for executing the condition judgment equation is generated and managed beforehand by a publicly known compiler, and this program module may interpret and execute the condition judgment equation.

In place of the condition judgment equation, a condition judgment program code described in a program language which the condition judgment module 1606 can interpret and execute may be stored as the control condition 1803. In this case, the condition judgment module 1606 loads the condition judgment program code by inputting judgment information necessary for condition judgment. The condition judgment program code returns a condition judgment result to execute condition judgment.

FIG. 15 is a flowchart of processing where the setting module 1609 sets the probe control module 1607 according to the first embodiment of this invention.

The setting module 1609 sets the probe control module 1607 by executing the flow of FIG. 15 based on the probe control definition.

In a step 2101, the setting module 1609 obtains probe control definition from the probe control definition storage module 1602.

In a step 2102, the setting module 1609 analyzes the control operation 1805 of the probe control definition to specify an ID of the probe 1610 to be controlled, and an operation for controlling the monitoring operation of the probe 1610.

In a step 2104, the setting module 1609 judges whether the monitoring operation control of the probe 1610 has been designated to be executed by inserting the probe 1610 into the application program 170 or removing the probe 1610 from the application program. If it is judged in the step 2104 that the control is executed by inserting or removing the probe 1610, the process is finished. If it is judged that the control is not executed by inserting or removing the probe 1610, the process proceeds to a step 2105.

In the step 2105, the setting module 1609 controls the management module 141 to generate a new probe 1610 which incorporates an operation control code for controlling the probe 1610 in the probe 1610 specified in the step 2102. The management module 141 generates a program code of the specified probe 1610 based on the probe control definition. In this case, the control module 142 incorporates the operation control code in the probe 1610 to be generated.

In a step 2106, the management module 141 inserts the probe 1610 which includes the operation control code generated in the step 2105 incorporated therein into the application program 170. If the probe 1610 specified in the step 2102 has been inserted, the program code of the old probe 1610 is replaced by a program code of the probe generated in the step 2105.

Through the processing, a function necessary for controlling the monitoring operation of the probe 1610 is set.

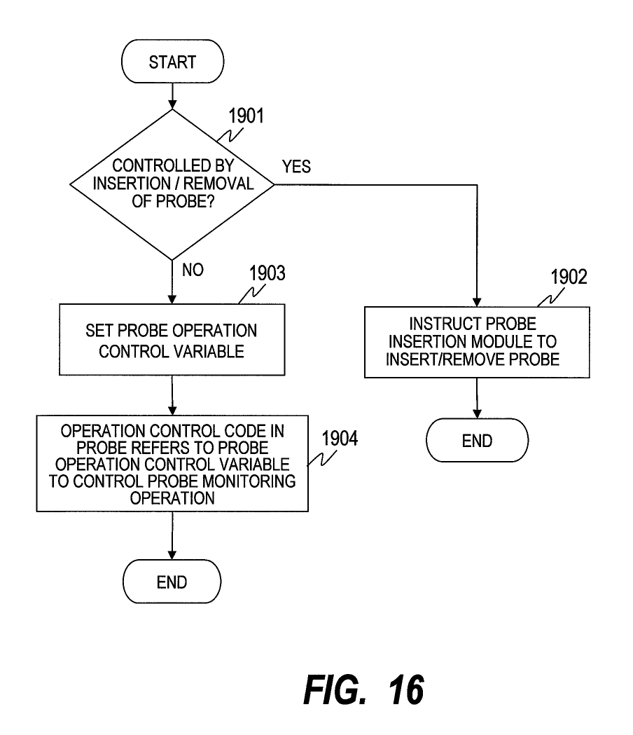

FIG. 16 is a flowchart of processing where the probe control module 1607 controls the operation of the probe 1610 according to the first embodiment of this invention.

In a step 1901, the probe control module 1607 judges whether to execute control of the monitoring operation of the probe 1610 by inserting or removing the probe 1610. For this judgment, for example, a table (not shown) where an ID 1801 of probe control definition is a key may be disposed in the probe control module 1607. In the table, a method of controlling the monitoring operation of the probe 1610 is stored. The probe control module 1607 can execute judgment of the step 1901 by referring to this table.

If it is judged in the step 1901 that the monitoring operation control of the probe 1610 is executed by inserting or removing the probe 1610, the process proceeds to a step 1902. On the other hand, if it is judged that the monitoring operation control of the probe 1610 is not executed by inserting or removing the probe 1610, the process proceeds to a step 1903.

In the step 1902, the probe control module 1607 designates an ID of the probe 1610 of a control target, and instructs the management module 141 to insert or remove the probe 1610. According to this instruction, the management module 141 executes designated insertion or removal of the probe 1610. As a result, the monitoring operation of the application program by the probe 1610 is started or stopped. Then, the control process of the probe operation is finished.

In a step 1903, the probe control module 1607 sets a value of an operation control variable allocated to the probe 1610 of the control target according to contents of the control.

In a step 1904, when the program code of the probe 1610 of the control target is executed, an operation control code is executed before an execution of a code for the monitoring operation. This operation control code is a code incorporated in the probe 1610 of the control target in the step 2105 of the flow shown in FIG. 15. The operation control code refers to the operation control variable, judges whether to execute a monitoring operation according to its value, and controls execution of the code for the monitoring operation. Then, the control process of the probe monitoring operation is finished.

According to this embodiment, collection of pieces of judgment information from the probes 1610 is executed via the collector 1620 of the monitor event output module 180a. However, data obtained by each probe 1610 may be directly output to the condition judgment module 1606 not via the collector 1620. In this case, in the step 2006 of the setting processing of the judgment information shown in the flow of FIG. 14, instead of setting the collector 1620 by the setting module 1609, the probe 1610 may be set by the management module 141. In this case, the management module 141 uses a probe code generation function to execute processing of incorporating a program code for directly transmitting a monitor item obtained by the probe 1610 from the probe to the condition judgment module 1606 through the interface disposed in the condition judgment module 1606.

According to this embodiment, the condition judgment module 1606 and the probe control module 1607 are both configured as parts of the condition control module 143. However, all or a part of the processing executed by the condition judgment module 1606 or the probe control module 1607 may be executed by the program code which the management module 141 incorporates during program code generation of the probe 1610 to control conditions.

In this case, a program code for executing processing such as acquisition and transfer of judgment information, condition judgment using the judgment information and transfer of the judgment result, and control of the probe monitoring operation based on the judgment result is generated in response to an instruction of the setting module 1609. Then, the generated program code is incorporated into the probe 1610 which outputs the judgment information or the probe 1610 of the control target of the monitoring operation.

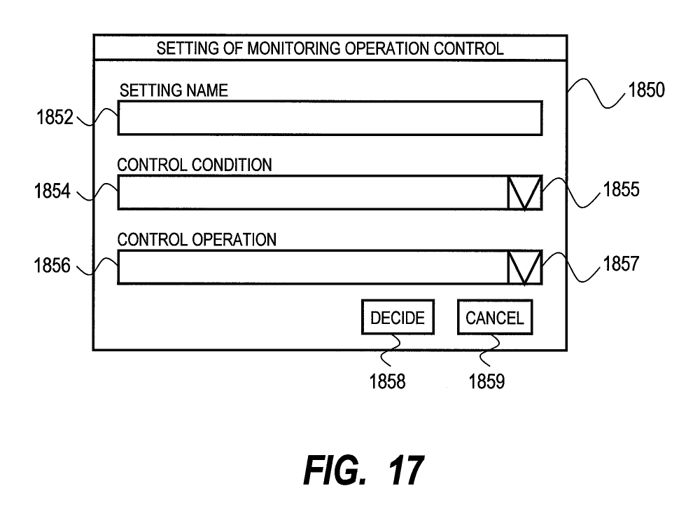

FIG. 17 is an explanatory diagram showing an example of a monitoring control setting user interface 110 used for inputting the probe control definition obtained from the probe control definition storage module 1602 according to the first embodiment of this invention.

The setting window 1850 of monitoring operation control is displayed in the output device 2711 to allow the user (e.g., operation or business administrator) to input the probe control definition.

The setting window 1850 of the monitoring operation control includes a setting name input section 1852, a control condition input section 1854, a control operation input section 1856, a decide button 1858, and a cancel button 1859.

The setting name input section 1852 is a section for inputting a name which is to be added to the input probe control definition, and is to be used by the user for management and identification.

A conditional equation for controlling the monitoring operation of the probe 1610 is input to the control condition input section 1854. Data used as judgment information in the conditional equation is designated by an ID of the probe 1610 and a predefined ID of the data acquisition module 1630.

An operation executed to control the monitoring operation of the probe 1610 when the condition input to the control condition input section is satisfied is input to the control operation input section 1857. In the control operation, an ID of the probe 1610 of a control target of a monitoring operation is designated.

The button 1855 is a button for displaying an interface for assisting the user to input a control condition. By a user interface (not shown) displayed as a result of operating the button 1855, a list of operators or functions that can be used for describing the control condition may be displayed. Further, a list of probes 1610 and data acquisition modules 1630 that can be used for the judgment information may be displayed. The user can select optional one from the displayed contents. The selected content is reflected in the control condition input section.

The button 1857 is a button for displaying an interface for assisting the user to input of a control condition. By a user interface (not shown) displayed as a result of operating the button 1857, a list of control operations that can be used for describing the control condition may be displayed. Further, a list of probes 1610 used as the control target of the monitoring operation may be displayed. The user can select optional one from the displayed contents. The selected content is reflected in the control condition input section.

After the user has input the setting name, the control condition, and the control operation, and the decide button 1858 is operated, the user interface 110 generates the probe control definition according to contents of the input items, and stores them in the probe definition storage module 1602.

The condition control of the monitoring operation of the probe 1610 of the system shown in FIG. 12 can be combined with a system which uses the user interface shown in FIG. 10 to be executed. In the system which uses the user interface shown in FIG. 10, monitoring setting is executed in design information, and probe definition is generated based on a “monitoring point” and “data to be monitored” of the design information designated by the monitoring setting. Specifically, as described above, the correspondence retrieval module 115 of FIG. 1 refers to the design correspondence storage module 130 to execute the processings of FIGS. 8 and 9, and specifies a point of inserting the probe 1610 and data to be monitored in a program code based on the designation of the design information.

In this case, when inputting the probe control definition, to designate the probe 1610 set as judgment information in the user interface shown in FIG. 17, the user can input the information of monitoring setting stored in the monitoring setting table shown in FIG. 11. The same applies to designation of the probe 1610 of a control target of a monitoring operation. The same ID is added to the monitoring setting and corresponding probe definition. Accordingly, the corresponding probe 1610 is specified based on the designated ID of the monitoring setting.

For example, to designate the probe 1610, the probe 1610 to be monitored may be displayed as “probe for monitoring first argument “d1” of FuncA.method1(String d1, String d2)” by using the probe definition. In this case, however, the user who has no knowledge of program implementation cannot understand a meaning of data obtained by the probe 1610. On the other hand, if it is displayed as “probe for monitoring input data “a” of function “1” of design information” by using the information of the monitoring setting, the user can easily understand its meaning.

When setting control of the monitoring operation of the probe 1610, the user can execute the setting without being aware of implementation of the application program 170 by using not the information of the probe definition but the information of the monitoring setting to designate the probe 1610.

When inputting a control condition, the user can input a monitoring point and data to be monitored in the design information by using the user interface shown in FIG. 10 without designating monitoring setting. In this case, when the monitoring setting is input in the design information, the correspondence retrieval module 115 of FIG. 1 refers to the design correspondence storage module 130 to generate new probe definition of the probe 1610 corresponding to the input monitoring setting. The generated probe 1610 is used as a probe 1610 for obtaining judgment information or a probe 1610 of a control target of the monitoring operation.

At this time, checking is made as to whether the same probe definition as the newly generated probe definition is present in the probe definition storage module. If the same probe 1610 is present, the probe 1610 is designated and the existing probe definition is used. On the other hand, if the same probe 1610 is not present, according to the newly generated probe definition, a probe 1610 for obtaining judgment information or a probe 1610 of a control target of a monitoring operation is newly generated to be inserted into the application program 170.

In setting of condition control of the probe 1610, when monitoring setting is executed in the design information by using the user interface shown in FIG. 10, the user may simultaneously input a control condition and a control operation. As a result, monitoring setting with conditions can be input. In this case, probe control definition is generated simultaneously with generation of the probe definition and is stored in the probe control definition storage module 1602.

Next, a configuration and an operation of the system for controlling the monitoring operation of the probe 1610 according to a probe load will be described. The probe load is a load generated when the probe 1610 inserted into the application program 170 executes monitoring of the application program 170. To prevent an influence such as a performance reduction of the probe load on execution of the application program 170, the probe load is measured, and the monitoring operation of the probe is controlled according to a measured value.

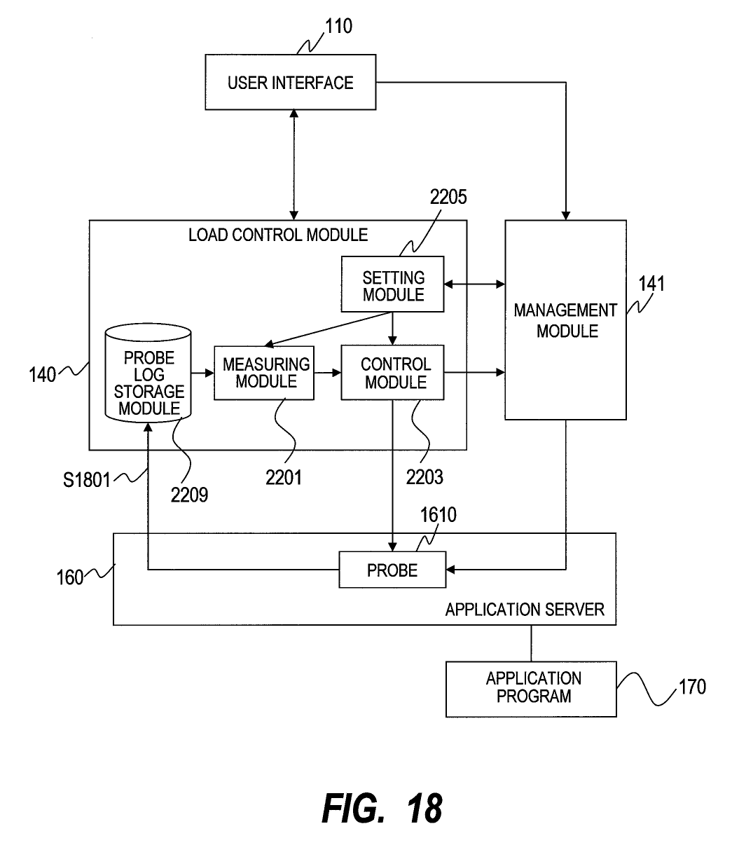

FIG. 18 is a block diagram showing a configuration of the system for controlling the monitoring operation of the probe 1610 based on the measured probe load according to the first embodiment of this invention.

A load control module 140 includes a measurement module 2202, a control module 2203, a setting module 2205, and a probe log storage module 2209. The management module 141 is the same as that shown in FIG. 3.

The probe log storage module 2209 is a storage area secured in the main memory 2705 or the external storage device 2707. The measurement module 2201, the control module 2203, and the setting module 2205 are program modules included in the management module 141. The probe 1610 is a program module inserted into the application program 170 by the management module 141 shown in FIG. 3.

First, processing of measuring the probe load will be described.

Upon reception of instruction of measuring the probe load, the setting module 2205 controls the probe 1610 inserted into the application program 170 to output a log of a monitoring operation of the probe 1610 (referred to as “probe log” hereinafter) during the measuring period of the probe load (S1801).

The probe log is information regarding a monitoring operation executed by the probe 1610, is output for each operation of the probe 1601, and is stored in the probe log storage module 2209. The probe log contains at least information indicating that the probe 1610 has been operated (i.e., probe 1610 has been executed). The probe log may further contain various pieces of information regarding processing executed by the probe 1610.

Processing for outputting the probe log may be executed by generating a probe 1610 which has a code for outputting a probe log incorporated therein and by inserting the generated probe 1610 again into the application program 170. Alternatively, the processing may be executed by incorporating a function of outputting a probe log beforehand in the probe 1610, and validating the function.

Otherwise, when information necessary for measuring the probe load can be obtained based on a monitor event output from the probe 1610, instead of outputting a probe log, the monitor event output module 180 may capture a monitor event output from each probe 1610. In this case, the monitor event output module 180 specifies a probe 1610 which has been operated based on a probe ID added to the monitor event, and extracts information equivalent to the probe log to output it to the probe log storage module 2209.

The measurement module 2201 obtains probe logs output from the probes 1610 from the probe log storage module 2209, and totals the probe logs to calculate a load of each probe 1610. For calculation of the probe load, the number of operation times (i.e., number of execution times) of each probe 1610 or the like is used. A description will be made below as to a case where the number of operation times of the probe is used as an example. The measurement module 2201 totals the probe logs, calculates the number of operation times of each probe 1610 per module time, and sets this value as a probe load.

After an end of the measuring period of the probe load, the setting module 2205 controls each probe 1610 to stop outputting of a probe log. If the probe 1610 having a code incorporated therein to output a probe log is generated to output the probe log, the setting module 2205 regenerates a probe 1610 from which an output code of the probe log has been removed. The setting module 2205 inserts the generated probe 1610 again into the application program 170 by using the management module 141.

Through the processing, a load of a monitoring operation of each probe 1610 is measured.

To reduce a load of measuring processing itself of the probe load, each probe 1610 may temporarily store a probe log, and output the probe logs en bloc at a predetermined interval instead of outputting the probe log for each operation of the probe 1610. Alternatively, the probe log temporarily stored in the probe 1610 may be totaled by each probe 1610, and only a statistically processed value may be output at a predetermined interval.

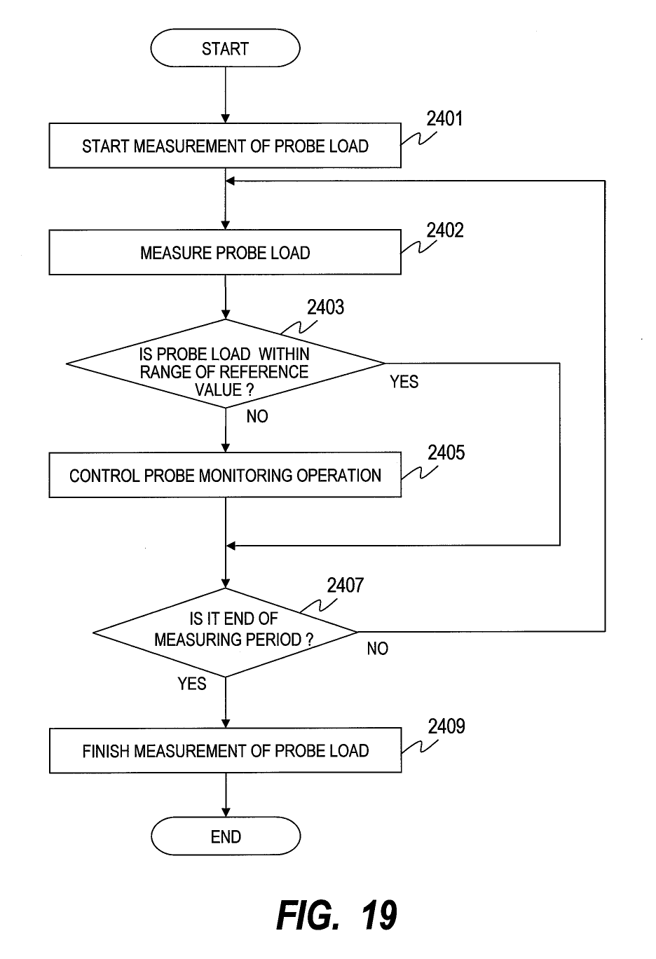

FIG. 19 is a flowchart of processing where the load control module 140 controls the monitoring operation of the probe 1610 based on a measured probe load according to the first embodiment of this invention.

First, in a step 2401, the load control module 140 starts measurement of a probe load. As described above, the probe 1610 having the code for outputting the probe log incorporated therein may be inserted into the application program 170, or a function of outputting a probe log may be validated.

In a step 2402, the load control module 140 measures a load of the probe 1610.

In a step 2403, the load control module 140 compares the measured probe load with a preset reference value of a probe load.

If it is judged in the step 2403 that the probe load satisfies the reference (i.e., probe load is within a range of the reference value), the process proceeds to a step 2407. On the other hand, if it is judged in the step 2403 that the probe load does not satisfy the reference, the probe load must be reduced to reduce an influence of the probe load on execution of the application program 170. Thus, the process proceeds to a step 2405.

In a step 2405, the load control module 140 controls a monitoring operation of the probe 1610 to reduce the probe load.

In a step 2407, the load control module 140 judges whether the set measurement period of the probe load has come to an end.

If it is judged in the step 2407 that the measurement period has not come to an end, the process returns to the step 2402 to continue the measurement of the probe load and the control of the monitoring operation.

On the other hand, if it is judged in the step 2407 that the measurement period has come to an end, the load control module 140 finishes the measurement of the probe load to terminate the process in a step 2409.

The reference value of the probe load compared in the step 2403 may be set based on an absolute value of a load of each probe 1610, or may be set based on a relative value with a load of the other probe 1610.

If the absolute value of the load is used, in the step 2403, the load control module 140 compares the load of each probe 1610 with the set reference value to judge whether the load is within the reference range. The reference value of the probe load is stored beforehand in the storage area of the load control module 140.

On the other hand, if the relative value of the load is used, in the step 2403, the load control module 140 calculates a relative value between a reference load of a probe 1610 and a load of a probe 1610 of a measuring target. Then, the load control module 140 compares the calculated relative value with the set reference value. When a probe load is evaluated by using the relative value, irrespective of the entire load of the application program 170, it is possible to discover a probe 1610 of an especially high load as compared with the other probes 1610.

If there is a probe 1610 whose load exceeds the reference value as a result of comparison with the reference value, the load control module 140 controls a monitoring operation of the probe 1610. As methods of controlling monitoring operations, for example, there are a method (1) of removing the probe 1610 from the application programs 170, a method (2) of thinning outputs of monitor data of the probe 1610, and the like.

According to the method (1), monitoring of the probe 1610 is completely stopped, and a program code of the probe 1610 is removed from the application program 170. Thus, an influence on execution of the application program is completely removed.

According to the method (2), by setting the number of outputting times of monitor data of the probe 1610 per a several number of processing times, the number of processing times for obtaining and outputting monitor data of the probe 1610 is reduced. As a result, a load of the probe 1610 is reduced.

The load control module 140 measures a probe load again after the execution of control of the monitoring operation.

In the case of executing control of the method (2) during measurement of a monitoring load of the probe 1610, irrespective of whether the probe 1610 has actually output monitor data, it is possible to more accurately measure a probe load by outputting a probe log every time the probe 1610 is operated. The probe log to be output at this time contains information indicating whether the monitor data has been output.

Alternatively, if a sum total of all the probe loads exceeds a reference value, the load control module 140 can control the entire load not to exceed the reference value by adjusting a value of each probe load through the processing. In this case, the load control module 140 calculates a target value of a load of each probe 1610 to control a monitoring operation of the probe 1610 by taking a load balance of each probe 1610 and importance of monitor data output from each probe 1610 into consideration.

Measurement and control of the probe load are executed when a new probe 1610 is added to the application program 170 or when instructed by the user.

When the new probe 1610 is added to the application program 170, the user interface 110 instructs the management module 141 to insert the new probe 1610 into the application program 170 and instructs the load control module 140 to measure a probe load.

The load control module 140 starts measurement and control of loads of the probes 1610 including the new probe 1610 in association with the insertion of the new probe 1610 into the application program 170 executed by the management module 141. Then, the load control module 140 executes the measurement and the control of probe loads for a preset period, and displays the measured probe loads and a state of the control of the monitoring operation to the user interface 110.

Additionally, the user may use the user interface 110 to optionally instruct execution of measurement and control of probe loads, and may set the reference value of the probe load and a control method or the like implemented when the load exceeds the reference value.

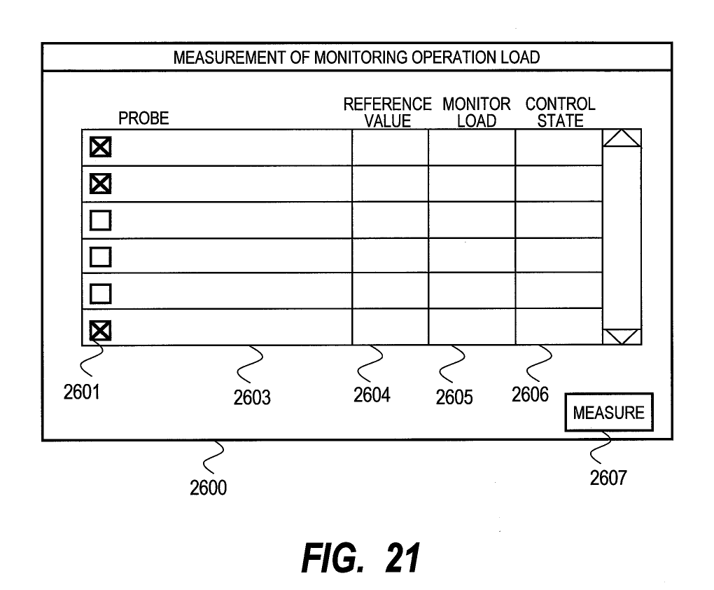

FIG. 21 is an explanatory diagram showing an example of the user interface 110 regarding measurement of a monitoring operation load according to the first embodiment of this invention.

Specifically, the user interface 110 of FIG. 21 allows the user to input a probe 1610 of a measuring target of a monitoring operation load, and displays a measuring result of the monitoring operation load of the input probe 1610.

A measurement probe setting window 2600 displays a list of probes 1610 stored in the probe definition storage module 1601 of the management module 141. Further, the measurement probe setting window 2600 displays a value of the measured probe load in a section 2605 when a load of the monitoring operation of each probe 1610 has been measured.

A check box 2601 is disposed in each line indicating each probe 1610. The user operates the check box 2601 to select a probe 1610 of a measuring target of a monitoring operation load.

A reference value of a load of each probe is displayed in a reference value input section 2604. The user can input a value into the reference value input section 2604.

When the user operates a measurement button 2607, the measurement and the control of the probe load are executed, the measured probe load is displayed in a probe load display section 2605, and a state of control of the monitoring operation is displayed in a control state display section 2606.

For each probe 1610 or all the probes 1610, an interface for inputting a permissible reference value of a probe load may be disposed, and measurement of the probe 1610 and control of a monitoring operation of a high-load probe may be executed in the flow shown in FIG. 19.

Alternatively, instead of controlling each probe 1610 to output a probe load, the probe load may be measured by measuring a performance index of the system or the application program 170.

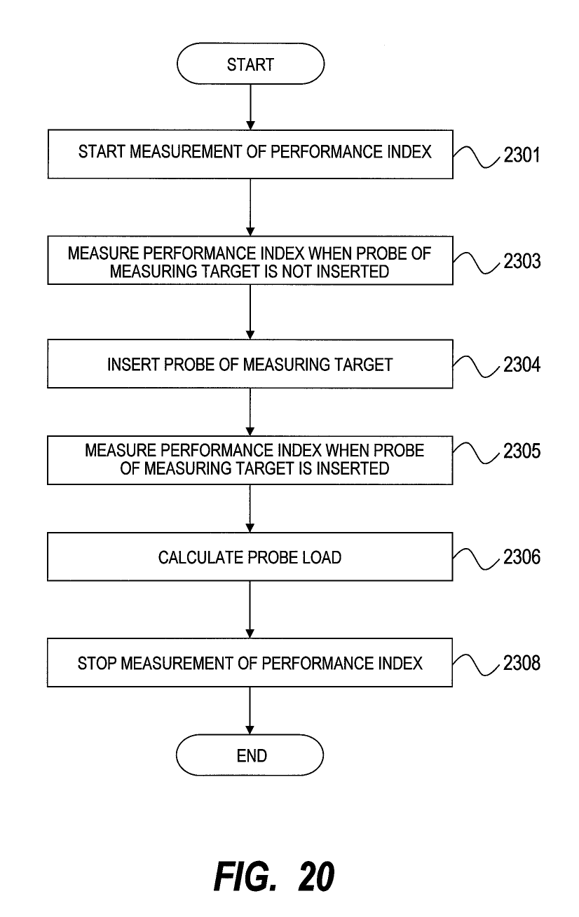

FIG. 20 is a flowchart of processing where the load control module 140 measures a probe load by measuring a performance index of the application program 170 according to the first embodiment of this invention.

In a step 2301, the load control module 140 starts measurement of an index indicating execution performance of the application program 170. The performance index may be measured by a function of the application server 160 or the like to measure the performance index. This embodiment will be described by way of a case where processing throughput of the application program 170 measurable in the application server 160 is set as a performance index used for measuring a probe load.

In a step 2303, the load control module 140 measures processing throughput of a state where the measuring target probe 1610 has not been inserted. Specifically, the application program 170 is executed in a state where the measuring target probe 1610 has not been inserted into the application program 170 to obtain average processing throughput for a predetermined period.

In a step 2304, the probe insertion module 1608 inserts the measuring target probe 1610 into the application program 170 to execute monitoring by the probe 1610.

In a step 2305, the application program 170 is executed in a state where the measuring target probe 1610 has been inserted to measure the average processing throughput for a predetermined period as in the case of the step 2303.

In a step 2306, the load control module 140 calculates a value of a probe load by using the values of the processing throughput measured in the steps 2303 and 2305.

Then, in a step 2308, the load control module 140 stops the measurement of the performance index set in the step 2301 to finish the measurement processing of the probe load.

Through the processing, a probe load of the measuring target probe 1610 is measured.

The performance index used for measuring the probe load is not limited to the processing throughput. By measuring a plurality of performance indexes, it is possible to measure a probe load more accurately.

In the flow of FIG. 20, the measurement of the performance index in the step 2305 and the calculation of the probe load in the step 2306 may be simultaneously executed. The processing of the step 2403 and after of FIG. 19 may be executed by using the calculated probe load. In this case, judgment is made as to whether the value of the calculated probe load is within the range of the reference value, and the monitoring operation of the probe 1610 is controlled when necessary. As a result, in the step 2305, without waiting for the end of the performance index measuring period, if a load of the measuring target probe 1610 is high, the monitoring operation of the measuring target probe 1610 is controlled, thereby making it possible to prevent an influence on the execution of the application program 170.

According to this embodiment, in the step 2303, the performance index is measured in the noninserted state of the measuring target probe 1610 for each measuring of a probe load. Then, in the step 2306, the influence of the probe 1610 is calculated by using the measured value. However, a performance index measured in the past may be recorded, and the calculation of the step 2306 may be executed by using the recorded value.

According to this embodiment, the measurements of the performance indexes in the inserted and noninserted states of the measuring target probe 1610 are separately carried out. If possible, however, both may be simultaneously executed. For example, when processing time of the method of inserting the measuring target probe 1610 is set as a performance index, the function of the load measuring probe 1610 may be incorporated in the program code of the measuring target probe 1610, and processing time including processing of the monitoring operation of the measuring target probe 1610, and processing time not including processing of the monitoring operation of the measuring target probe 1610 may be simultaneously measured. As a result, it is possible to obtain a load of the measuring target probe by simultaneously measuring both the processing times.

The first embodiment of this invention is based on the premise that one component of the design information has a design correspondence with only one component of the program code. A second embodiment will be described below by way of an example where a plurality of components of a program code corresponds to one component of design information.

Only differences of the second embodiment of this invention from the first embodiment will be described below. Components of the second embodiment not described below are similar to those of the first embodiment.

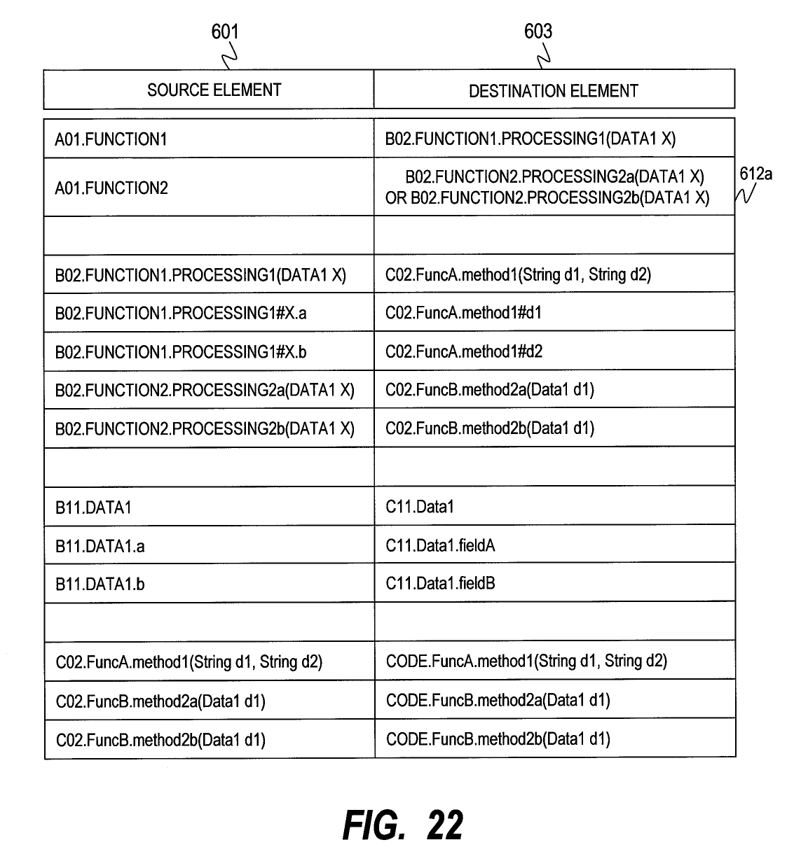

FIG. 22 is an explanatory diagram showing an example of a design correspondence according to the second embodiment of this invention.

Specifically, FIG. 22 shows an example of design correspondence information when one or more components of a program code correspond to one component. When the plurality of components corresponds to one component, object ID's of corresponding components, and a relation among the components are stored in a correspondence destination element 603. The example of FIG. 22 shows that, in a design correspondence 612a, processing of “function 2” is executed by one of two methods according to a situation.

As in the case of the first embodiment, the correspondence retrieval module 115 of this embodiment executes retrieval processing of a component of a corresponding program code as shown in FIGS. 8 and 9. However, when there is a design correspondence such as a design correspondence 612a, the correspondence retrieval module 115 retrieves a plurality of components. The correspondence retrieval module 115 executes processing shown in FIGS. 8 and 9 for each of the plurality of retrieved components, retrieves components of a corresponding program code, and generates a set of a plurality of probe definitions for realizing designated monitoring.

For example, in the example of FIG. 5, when “A01.Function2” is designated as a monitoring place, two methods of “FuncB.method2a(Data1 d1)” and “FuncB.method2b(Data1 d1)” are retrieved as monitoring places of a program code corresponding to the designated places. As a result, probe definitions are generated according to the places. The same probe ID 1001 and a serial number for identifying each probe (probe subID 1002) are added to the probe definitions.

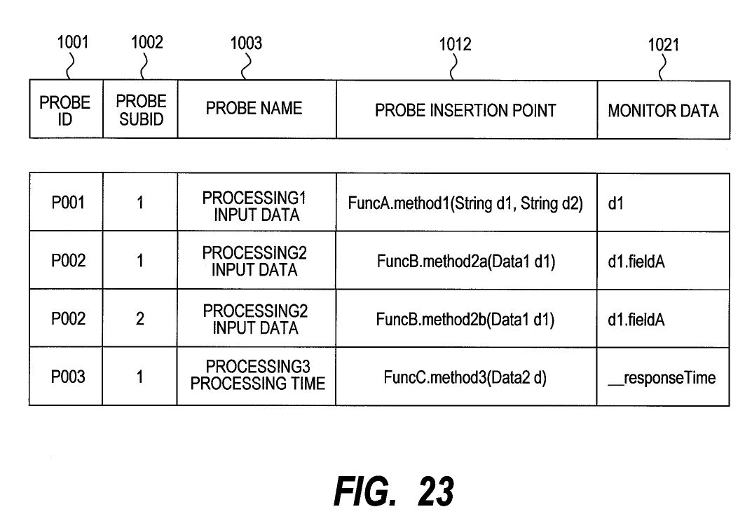

FIG. 23 is an explanatory diagram showing a configuration example of a probe definition storage module 1601 according to the second embodiment of this invention.

Specifically, FIG. 23 shows an example of a probe definition when the design correspondence is as shown in FIG. 22. 2nd and 3rd lines of FIG. 23 indicate a probe 1610 inserted into a method “FuncB.method2a(Data1 d1)” corresponding to the “A01.Function2”, and a probe 1610 inserted into a method “FuncB.method2b(Data1 d1)”, respectively. These probes 1610 have the same probe ID 1001 “P002”, and are identified by different probe subID 1002 “1” and “2”.

A management module 141 designates a probe 1610 which becomes a target by using the probe ID 1001, generates probes 1610 based on all probe definitions having the designated probe ID 1001, and executes insertion and removal. In the example shown in FIG. 23, when the management module 141 instructs insertion of probes whose probe ID's 1001 are “P002”, two probes 1610 are generated to be inserted into the application program 170.

According to embodiments of this invention, even the business or operation administrator having no knowledge of program implementation can designate monitoring of the application program on upstream application design information understandable from a viewpoint of a business. A program module for realizing the designated monitoring is immediately added to the application program or changed without requiring any work on a designer or a programmer. Further it is possible to easily realize proper monitoring according to an execution state of the application program by operating a plurality of monitoring functions in cooperation without any programming work. Furthermore, it is possible to prevent casual monitoring setting from causing serious performance deterioration in execution of the application program to thereby safely set application monitoring.

Representative aspects of this invention outside the scope of claims are as follows.

(1) A computer system, including an application server for executing an application program, which is configured to:

hold an operation to be executed to control program modules for monitoring the application program, and a condition used for judging whether to execute the operation; and

execute the operation when the condition is satisfied.

(2) The computer system according to the above-mentioned item (1), which is configured to:

execute at least one of the program modules for monitoring the application program; and

judge whether the condition is satisfied based on data obtained by one of the program modules.

(3) The computer system according to the above-mentioned item (1), in which the operation to be executed to control the program module for monitoring the application program is one of insertion of the program module into the application program and removal of the program module from the application program.

(4) The computer system according to the above-mentioned item (1), which is configured to generate a program code for executing all or a part of judgment as to whether to execute the operation, and the operation to be executed as a result of the judgment.

(5) The computer system according to the above-mentioned item (1), further including a user interface for inputting an operation to be executed to control the program module for monitoring the application program and the condition used for judging whether to execute the operation.

(6) The computer system according to the above-mentioned item (5), which is configured to:

hold information indicating a correspondence between a component of design information at one stage of a development process of the application program and a component of design information at a more advanced stage than the one stage; and

designate, when information indicating one of a point and data of a business process is input, one of a program module for executing the operation and a program module for obtaining data used for judging whether to execute the operation based on the input information and the information indicating the correspondence.

(7) The computer system according to the above-mentioned item (6), which is configured to generate a new designated program module when the designated program module is not present.

(8) A computer system, including an application server for executing an application program, which is configured to measure a load generated by inserting and executing a program module for monitoring the application program in the application program.

(9) The computer system according to the above-mentioned item (8), which is configured to measure the load based on a log of a monitoring operation of the program module for monitoring the application program.

(10) The computer system according to the above-mentioned item (8), which is configured to measure the load based on a performance index in execution of the application program.

(11) The computer system according to the above-mentioned item (8), which is configured to control the operation of the program module for monitoring the application program when the measured load does not satisfy a predetermined condition.

(12) The computer system according to the above-mentioned item (11), which is configured to control the operation of the program module for monitoring the application program by removing the program module when the measured load does not satisfy a predetermined condition.

(13) The computer system according to the above-mentioned item (8), which is configured to:

measure the load generated by the program module for monitoring the application program when the program module is inserted into the application program; and

control an operation of the program module when the measured load does not satisfy a predetermined condition.

(14) The computer system according to the above-mentioned item (13), which is configured to control the operation of the program module for monitoring the application program by removing the program module when the measured load does not satisfy a predetermined condition.

(15) The computer system according to the above-mentioned item (8), further including a user interface for inputting the program module of a load measuring target and a condition, and displaying the measured load.

By using this invention, it is possible to easily set and execute application monitoring without being conscious of the implementation of the application program.

While the present invention has been described in detail and pictorially in the accompanying drawings, the present invention is not limited to such detail but covers various obvious modifications and equivalent arrangements, which fall within the purview of the appended claims.

1. A computer system for executing an application program, comprising a processor and a memory coupled to the processor, wherein the computer system is configured to:
hold information indicating a correspondence between a component of design information at a stage of a development process of the application program and a component of design information at the following stage of the development process; and
correlate the component of the design information at one of the stages of the development process of the application program with a code of the application program based on the information indicating the correspondence.

2. The computer system according to claim 1, wherein:
the component of the design information correlated with the code of the application program is information indicating a point in a business process; and
the computer system correlates the point of the business process with a point of the code of the application program based on the information indicating the correspondence.

3. The computer system according to claim 2, wherein the computer system is configured to:
correlate, upon input of the information indicating the point of the business process, the point of the business process identified by the input information with the point of the code of the application program based on the information indicating the correspondence; and
insert a program module for monitoring the application program into the correlated point of the code of the application program.

4. The computer system according to claim 3, wherein the program module inserted into the application program monitors the application program by obtaining log information of the application program.

5. The computer system according to claim 4, wherein the log information contains one of information indicating data to be processed by the application program and information indicating processing time of the application program.

6. The computer system according to claim 3, comprising a user interface for inputting the information indicating the point of the business process.

7. The computer system according to claim 1, wherein:
the component of the design information correlated with the code of the application program is information indicating data to be processed in a business process; and
the computer system correlates the data to be processed in the business process with data in the code of the application program based on the information indicating the correspondence.

8. The computer system according to claim 7, wherein the computer system is configured to:
correlate, upon input of the information indicating the data to be processed in the business process, the data to be processed in the business process identified by the input information with the data in the code of the application program based on the information indicating the correspondence; and
generate a program module for obtaining the correlated data.

9. The computer system according to claim 8, wherein the data obtained by the program module includes log information of the application program.

10. The computer system according to claim 8, comprising a user interface for inputting the information indicating the data to be processed in the business process.

11. The computer system according to claim 1, wherein the component of the design information correlated by the computer system is at least one of an activity and connection flow of a business process diagram, a message of a UML sequence diagram, a class, a method, and a field of a class diagram, and a class, a method, and a field of a program code.

12. The computer system according to claim 11, wherein the computer system is configured to:
add a unique identifier to the component of each design information; and
manage the information indicating the correspondence of the component of the design information by using the identifier.

13. A method of controlling a computer system for executing an application program, wherein the computer system includes a processor and a memory coupled to the processor,
the method comprising:
holding information indicating a correspondence between a component of design information at a stage of a development process of the application program and a component of design information at the following stage of the development process; and
correlating the component of the design information at one of the stages of the development process of the application program with a code of the application program based on the information indicating the correspondence.

14. The method according to claim 13, wherein:
the component of the design information correlated with the code of the application program is information indicating a point of a business process; and
the method further comprises:
correlating, upon input of the information indicating the point of the business process, the point of the business process identified by the input information with a point of the code of the application program based on the information indicating the correspondence; and
inserting a program module for monitoring the application program into the correlated point of the code of the application program.

15. The method according to claim 13, wherein:
the design information correlated with the code of the application program is information indicating data to be processed in a business process; and
the method further comprises:
correlating, upon input of the information indicating the data to be processed in the business process, the data to be processed in the business process identified by the input information with data in the code of the application program based on the information indicating the correspondence; and
generating a program module for obtaining the correlated data.

16. A program for controlling a computer system which executes an application program,
the computer system including a memory for storing the program and a processor for executing the program stored in the memory, and holds information indicating a correspondence between a component of design information at a stage of a development process of the application program and a component of design information at the following stage of the development process,
the program comprising causing the processor to execute a first procedure of correlating the component of the design information at one of the stages of the development process of the application program with a code of the application program based on the information indicating the correspondence, wherein:
the component of the design information correlated with the code of the application program is information indicating a point of a business process;
the first procedure includes correlating, upon input of the information indicating the point of the business process, the point of the business process identified by the input information with a point of the code of the application program based on the information indicating the correspondence,
the program further comprising causing the processor to execute a second procedure of inserting a program module for monitoring the application program into the correlated point of the code of the application program.

17. The program according to claim 16, wherein:
the first procedure further includes correlating, upon input of the information indicating the data to be processed in the business process, the data to be processed in the business process identified by the input information with data in the code of the application program based on the information indicating the correspondence; and
the program further comprises causing the processor to execute a third procedure of generating a program module for obtaining the correlated data.
